(19) United States
(12) Patent Application Publication
(10) Pub. No.: US 2020/0104425 A1
(43) Pub. Date: Apr. 2, 2020

(54) TECHNIQUES FOR LOSSLESS AND LOSSY LARGE-SCALE GRAPH SUMMARIZATION

(71) Applicant: Microsoft Technology Licensing, LLC, Redmond, WA (US)

(72) Inventors: Kijung Shin, Seoul (KP); Amol Ghoting, San Ramon, CA (US); Myunghwan Kim, Milpitas, CA (US); Hema Raghavan, Mountain View, CA (US)

(21) Appl. No.: 16/146,403

(22) Filed: Sep. 28, 2018

(51) Int. Cl. G06F 17/30

(52) U.S. Cl. CPC G06F 17/30958; G06F 17/30994; G06F 17/30949; G06F 17/30864

(57) ABSTRACT

Computer-implemented techniques for lossless and lossy summarization of large-scale graphs. Beneficially, the lossless summarization process is designed such that it can be performed in a parallel processing manner. In addition, the lossless summarization process is designed such that it can be performed with having to store only a certain small number of adjacency list node objects in-memory at once and without having to store an adjacency list representation of the entire input graph in-memory at once. In some embodiments, the techniques involve further summarizing the reduced graph output from the lossless summarization process in a lossy manner. Beneficially, the lossy summarization process uses a condition that is computationally efficient to evaluate when determining whether to drop edges of the reduced graph while at the same time ensuring the accuracy of a graph restored from the lossy reduced graph compared to the input graph is within the error bound.

### TECHNICAL FIELD

The present disclosure relates generally to computed-implemented techniques for summarization of large-scale graphs such as for example terabyte-scale or petabyte-scale web graphs.

### BACKGROUND

Graphs are ubiquitous in computing. Virtually all aspects of computing involve graphs including social networks, collaboration networks, web graphs, internet topologies, citation networks, to name just a few. The large volume of available data, the low cost of storage, and the rapid success and growth of online social networks and so-called “Web 2.0” applications have led to large-scale graphs of unprecedent size (e.g., web-scale graphs with tens of thousands to tens of billions of edges). As a result, providing efficient in-memory processing of large-scale graphs, such as, for example, supporting real-time queries of large-scale graphs, presents a significant technical challenge.

Graph summarization is one possible technique for supporting efficient in-memory processing of large-scale graphs. Generally, graph summarization involves storing graphs in computer storage media in a summarized form. The computational time performance of current graph summarization approaches generally worsens substantially as the size of the graphs increase. Current graph summarization approaches include the lossless and lossy summarization algorithms described in the following papers:
Navlakha, Saket, Rajeev Rastogi, and Nisheeth Shrivastava. “Graph summarization with bounded error.” Proceedings of the 2008 ACM SIGMOD international conference on Management of data. ACM, 2008.
Khan, KifayatUllah, Waqas Nawaz, and Young-Koo Lee. “Set-based approximate approach for lossless graph summarization.” Computing 97.12 (2015): 1185-1207.

Many large-scale graphs including web-scale graphs will only continue to grow as user engagement with online services, including social networking services, continues to increase. Thus, more scalable graph summarization techniques for large-scale graphs are needed.

Computer-implemented techniques disclosed herein address these and other issues.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The appended claims may serve as a useful summary of some embodiments of computer-implemented techniques for lossless and lossy summarization of large-scale graphs.

### BRIEF DESCRIPTION OF THE DRAWINGS

In the drawings:

FIG. 1A depicts an example input graph, according to some embodiments.

FIG. 1B, FIG. 1C, FIG. 1D depict an example of lossless graph summarization, according to some embodiments.

FIG. 1E, FIG. 1F, FIG. 1G depict an example of lossless graph restoration, according to some embodiments.

FIG. 1H depicts an example of lossy graph summarization, according to some embodiments.

FIG. 1J depicts an example of lossy graph restoration, according to some embodiments.

FIG. 2 depicts an example graph summarization process, according to some embodiments.

FIG. 3A depicts an example result of an initialization step of a graph summarization process, according to some embodiments.

FIG. 3B depicts an example result of a first iteration of a dividing step of a graph summarization process, according to some embodiments.

FIG. 3C depicts an example result of a first iteration of a merging step of a graph summarization process, according to some embodiments.

FIG. 3D depicts an example reduced graph after a first iteration of a dividing step and a merging step of a graph summarization process, according to some embodiments.

FIG. 3E depicts an example result of a second iteration of a dividing step of a graph summarization process, according to some embodiments.

FIG. 3F depicts an example result of a second iteration of a merging step of a graph summarization process, according to some embodiments.

FIG. 3G depicts an example reduced graph after a second iteration of a dividing step and a merging step of a graph summarization process, according to some embodiments.

FIG. 4 depicts an example dividing step of a graph summarization process, according to some embodiments.

FIG. 5 depicts an example merging step of a graph summarization process, according to some embodiments.

FIG. 6, FIG. 7 depict an example dropping step of a graph summarization process, according to some embodiments.

FIG. 8 depicts an example graph summarization system, according to some embodiments.

FIG. 9 depicts an example computer system that may be used in an implementation of an embodiment.

### DETAILED DESCRIPTION

In the following detailed description, for the purposes of explanation, numerous specific details are set forth in order to provide a thorough understanding of various embodiments of computer-implemented techniques for lossless and lossy summarization of large-scale graphs. It will be apparent, however, that the embodiments may be practiced without these specific details. In other instances, well-known structures and devices are shown in block diagram form in order to avoid unnecessarily obscuring the embodiments.

### General Overview

Computer-implemented techniques for lossless and lossy summarization of large-scale graphs are disclosed. The techniques are efficient, summarizing large-scale input graphs in both lossless and lossy manners and in a way that is faster than current graph summarization algorithms while providing similar data storage savings in some embodiments, thereby improving graph summarization systems. In some implementations, the techniques are combinable with known graph-compression techniques to provide additional data storage savings through compression, thereby improving graph compression systems.

In some embodiments, the techniques involve summarizing an input graph in a lossless manner. The lossless summarization process encompasses a number of steps that, given an input graph, efficiently outputs a reduced graph with fewer edges than the input graph but yet from which the input graph can be completely restored. Beneficially, the lossless summarization process is designed such that it can be performed in a parallel processing manner, thereby improving graph summarization systems. In addition, the lossless summarization process is designed such that it can be performed with having to store only a certain small number of adjacency list node objects in-memory at once and without having to store an adjacency list representation of the entire input graph in-memory at once, thereby improving graph summarization systems.

In some embodiments, the techniques involve further summarizing the reduced graph output from the lossless summarization process in a lossy manner. As a result of the lossy summarization process, the input graph may not be able to be completely restored from the lossy reduced graph output by the lossy summarization process. However, the difference in the number of edges between a graph restored from the lossy reduced graph and the input graph is within an error bound. Beneficially, the lossy summarization process uses a condition that is computationally efficient to evaluate when determining whether to drop edges of the reduced graph while at the same time ensuring the accuracy of a graph restored from the lossy reduced graph compared to the input graph is within the error bound, thereby improving graph summarization systems.

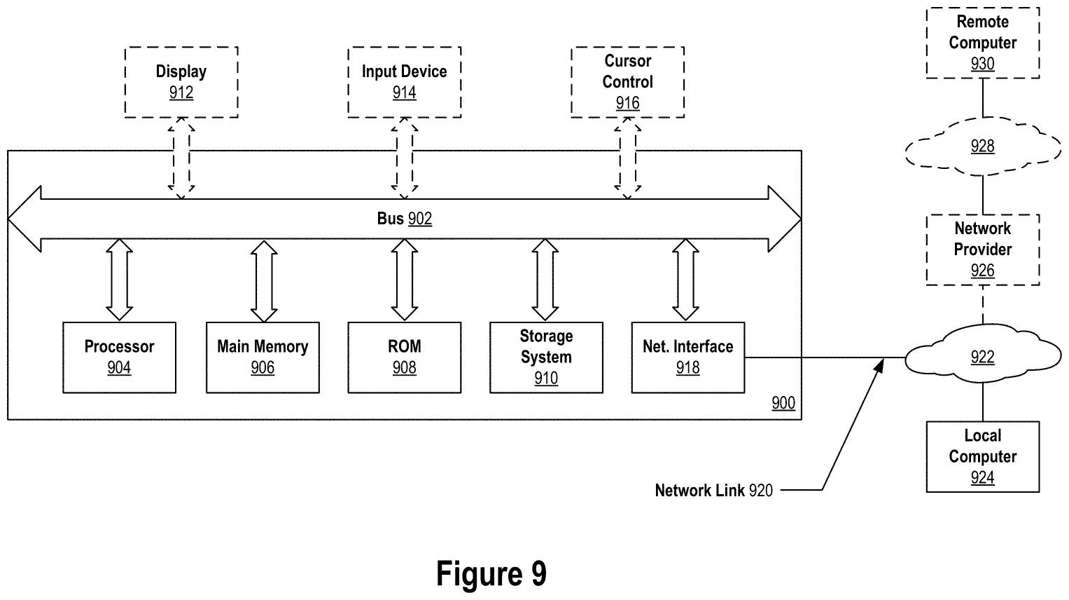

An implementation of the techniques may encompass performance of a method or process by a computing system having one or more processors and storage media. The one or more processors and storage media may be provided by one or more computer systems. An example computer system is described below with respect to FIG. 9. The storage media of the computing system may store one or more computer programs. The one or more computer programs may include instructions configured to perform the method or process.

In addition, or alternatively, an implementation of the techniques may encompass instructions of one or more computer programs. The one or more computer programs may be stored on one or more non-transitory computer-readable media. The one or more stored computer programs may include instructions. The instructions may be configured for execution by a computing system having one or more processors. The one or more processors of the computing system may be provided by one or more computer systems. The computing system may or may not provide the one or more non-transitory computer-readable media storing the one or more computer programs.

In addition, or alternatively, an implementation of the techniques may encompass instructions of one or more computer programs. The one or more computer programs may be stored on storage media of a computing system. The one or more computer programs may include instructions. The instructions may be configured for execution by one or more processors of the computing system. The one or more processors and storage media of the computing system may be provided by one or more computer systems.

If an implementation encompasses multiple computer systems, the computer systems may be arranged in a distributed, parallel, clustered or other suitable multi-node computing configuration in which computer systems are continuously, periodically or intermittently interconnected by one or more data communications networks (e.g., one or more internet protocol (IP) networks.)

### Graph Representation in a Computer

As mentioned, graphs can be very large. For example, current graphs can have tens of thousands to tens of billions of edges or more and may require terabytes or petabytes or more of data storage. As a result, it can be impractical to store an adjacency list representation of the entire graph in main memory at once.

In this description, the term “main memory” is used to refer to volatile computer memory and includes any non-volatile computer memory used by an operating system to implement virtual memory. The term “storage media” encompasses both volatile and non-volatile memory devices. The term “in-memory” refers to in main memory.

In some embodiments, an input graph is summarized in a lossless and/or lossy manner to produce a reduced graph. Because of the summarization, the reduced graph has fewer edges than the input graph. Because of the fewer number of edges, an adjacency list representation of the reduced graph may be able to be stored entirely within main memory of a computer system at once where such may not be possible with the input graph. Even if it is possible to store an adjacency list representation of the entire input graph in-memory at once, the reduced graph may occupy a smaller portion of main memory because of its fewer number of edges. Further, the ability to summarize the input graph as a smaller reduced graph reduces the rate at which main memory storage capacity must grow as the size of the input graph grows, which is useful for ever-growing graphs such as for example social networking graphs and web graphs.

### Input Graph

A graph is a set of nodes and edges. Each node may represent an entity such as for example a member of a social network. Each edge may connect two of the nodes and represents a relationship between the two entities represented by the two nodes connected by the edge. For example, an edge may represent a friend relationship between two members of a social network, or an edge may represent a hyperlink from one web page on the internet to another web page on the internet. As indicated by the previous examples, an edge can be undirected or directed. Further, two nodes can be connected in the graph by multiple edges representing different relationships between the two entities represented by the two nodes.

A graph can be represented in computer storage media in a variety of different ways including as an adjacency list. In general, an adjacency list representation for a graph associates each node in the graph with the collection of its neighboring edges. Many variations of adjacency list representations exist with differences in the details of how associations between nodes and collections of neighboring edges are represented, including whether both nodes and edges are supported as first-class objects in the adjacency list, and what kinds of objects are used to represent the nodes and edges.

Some possible adjacency list implementations of a graph including using a hash table to associate each node in the graph with an array of adjacent nodes. In this representation, a node may be represented by a hash-able node object and there may be no explicit representation of the edges as objects.

Another possible adjacency list implementation involves representing the nodes by index numbers. This representation uses an array indexed by node number and in which the array cell for each node points to a singly liked list of neighboring nodes of that node. In this representation, the singly linked list pointed to by an array cell for a node may be interpreted as a node object for the node and the nodes of the singly linked list may each be interpreted as edge objects where the edge objects contain an endpoint node of the edge. For undirected graphs, this representation may require two different singly linked lists for each edge, one edge object in each of the lists for the two endpoint nodes of the edge.

Still another possible adjacency list implementation is an object-oriented one. In this implementation, each node object has an instance variable pointing to a collection object that lists the neighboring edge objects and each edge object points to the two node objects that the edge connects. The existence of an explicit edge object provided flexibility in storing additional information about edges.

Regardless of the particular implementation, however, the fewer number of edges of the graph, the smaller, in general, the computer storage media requirements for storing an adjacency list representation of the graph. Accordingly, the graph summarization processes described herein has the overall goal of reducing the number of edges in the reduced graph relative to the input graph.

Example of graph summarization processes disclosed herein are provided in the context of undirected graphs. However, one skilled in the art will appreciate from this disclosure that the disclosed processes can be applied to directed graphs or graphs with a combination of undirected and directed edges without loss of generality.

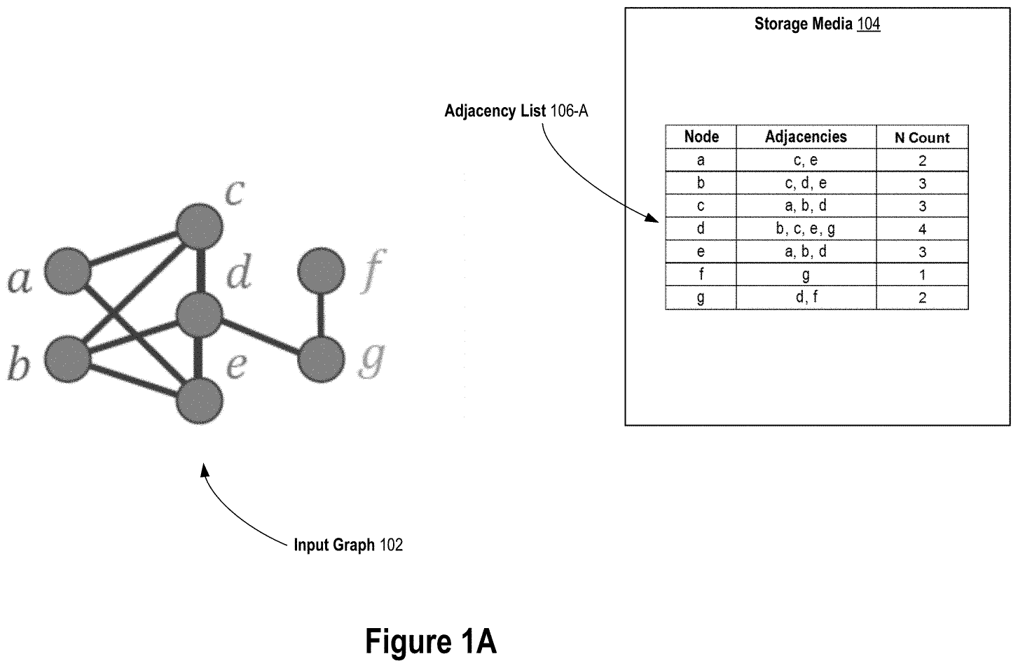

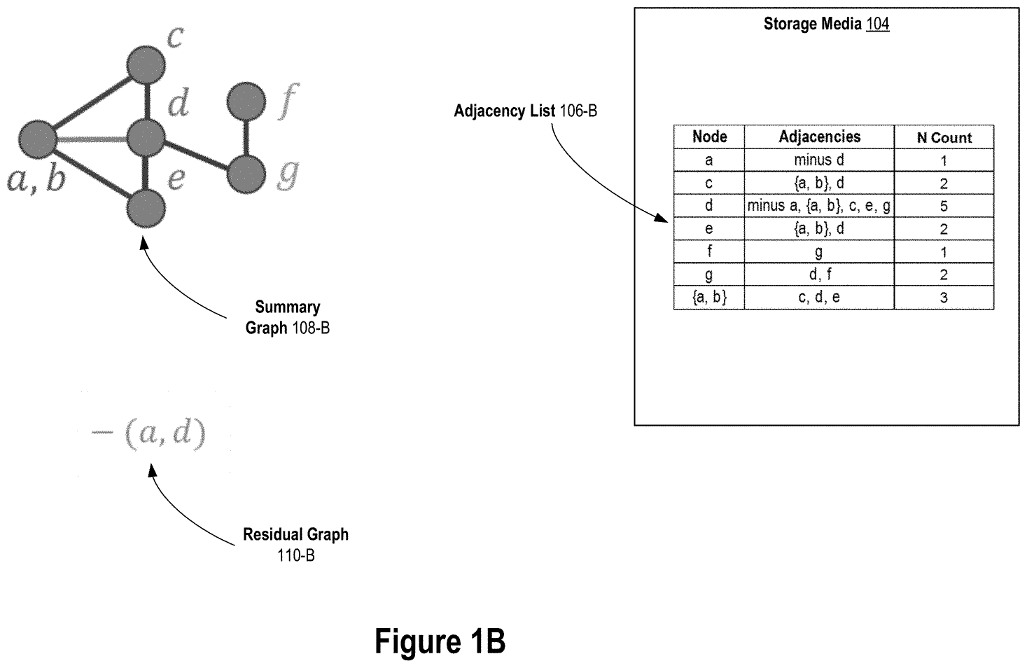

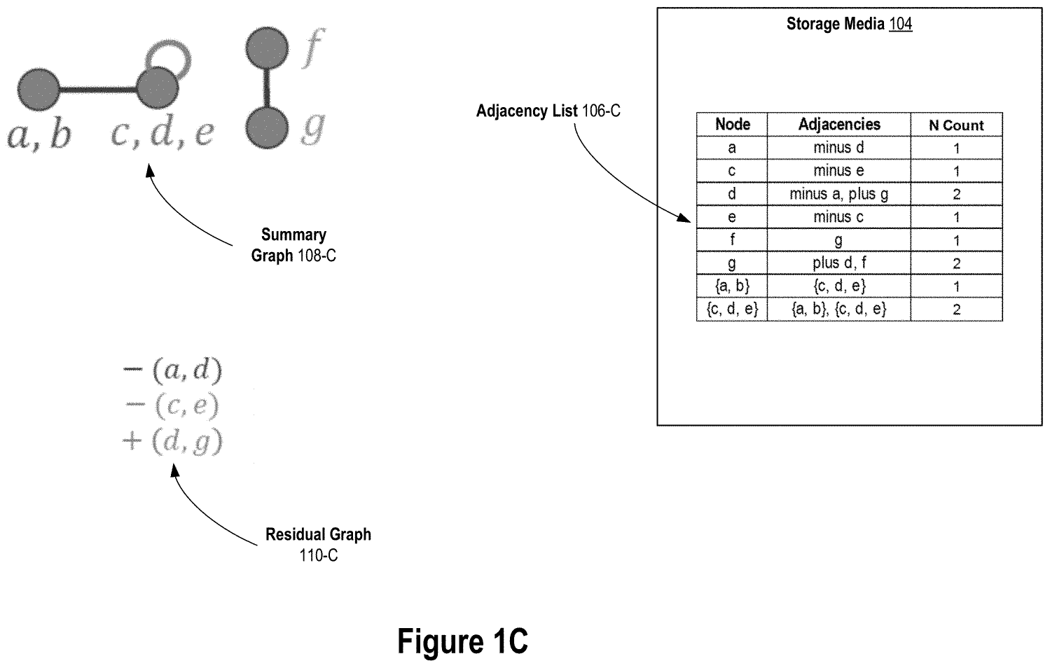

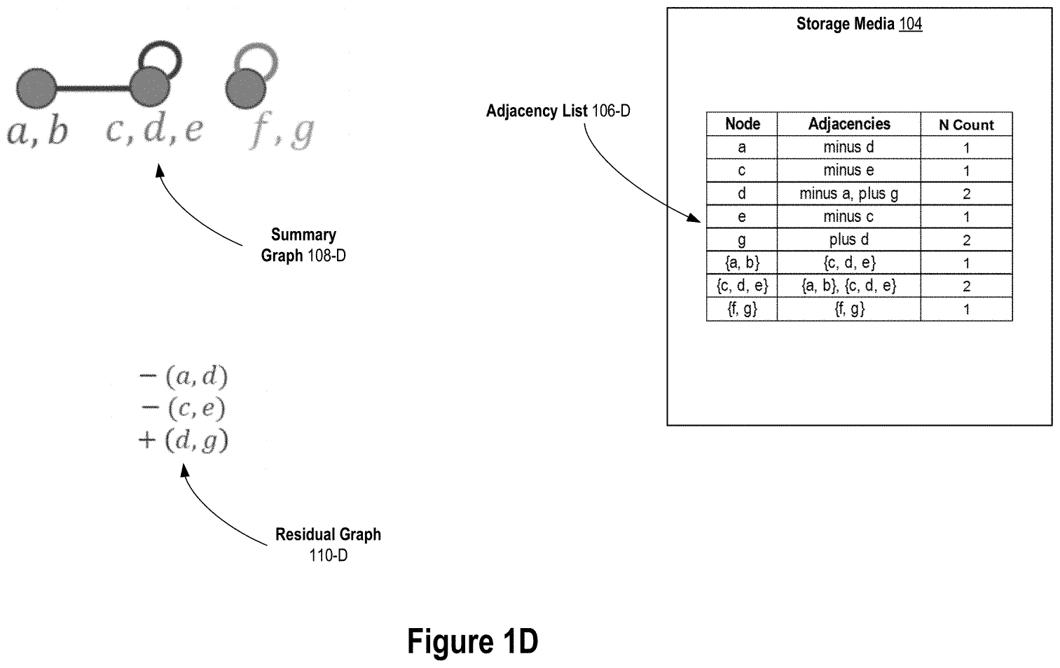

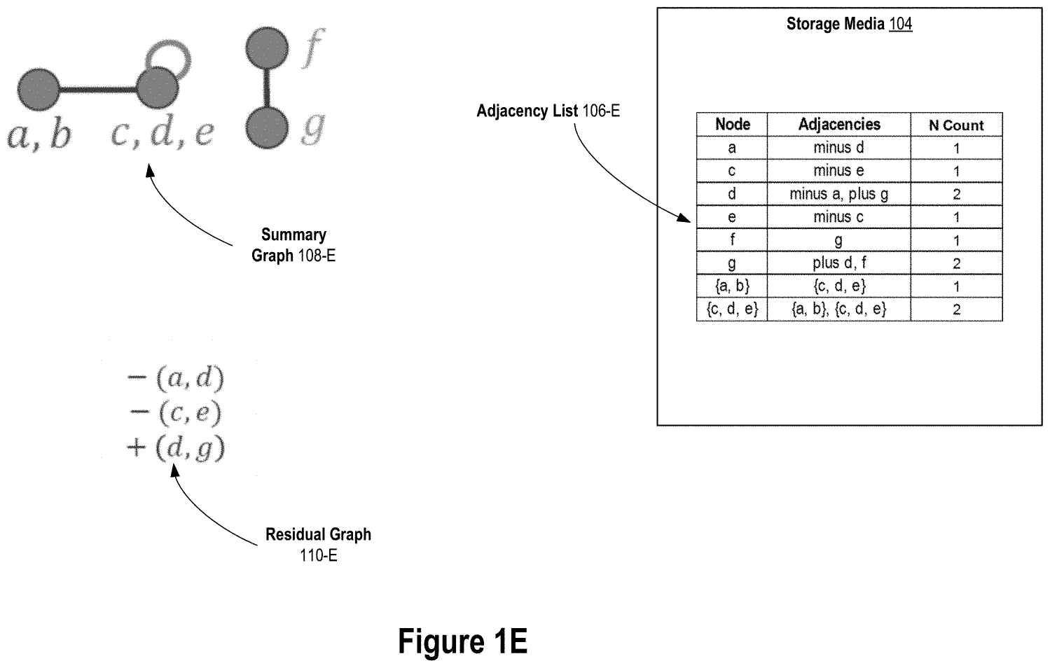

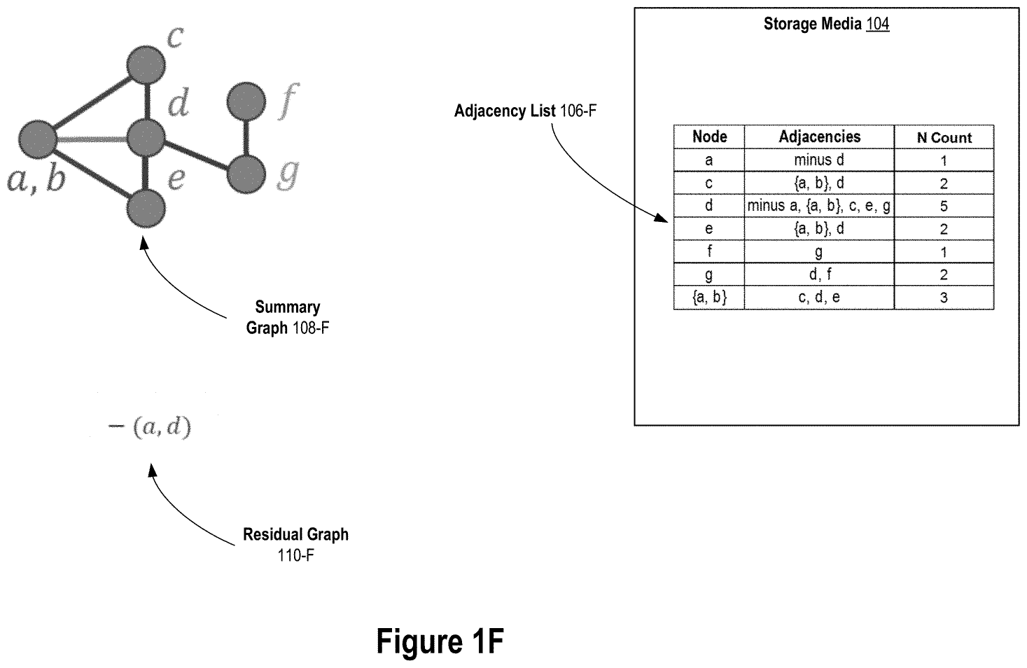

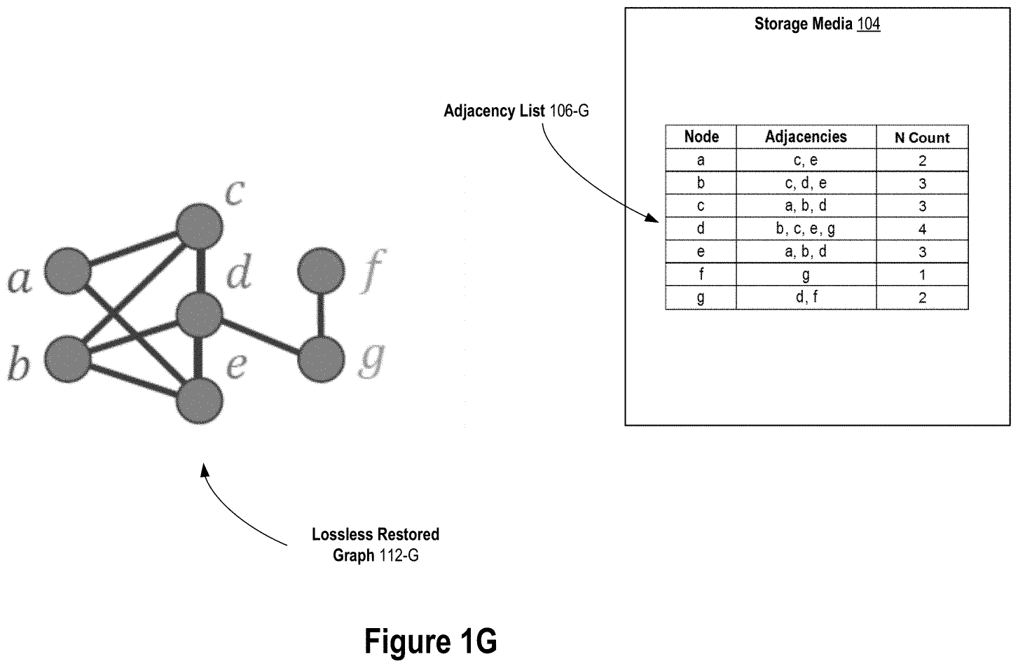

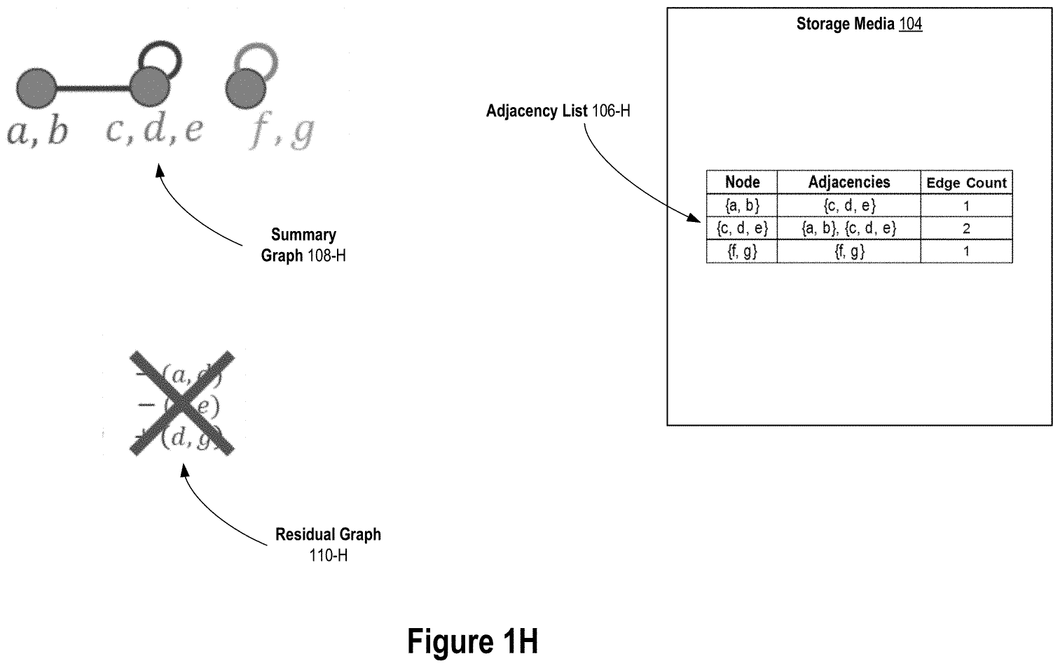

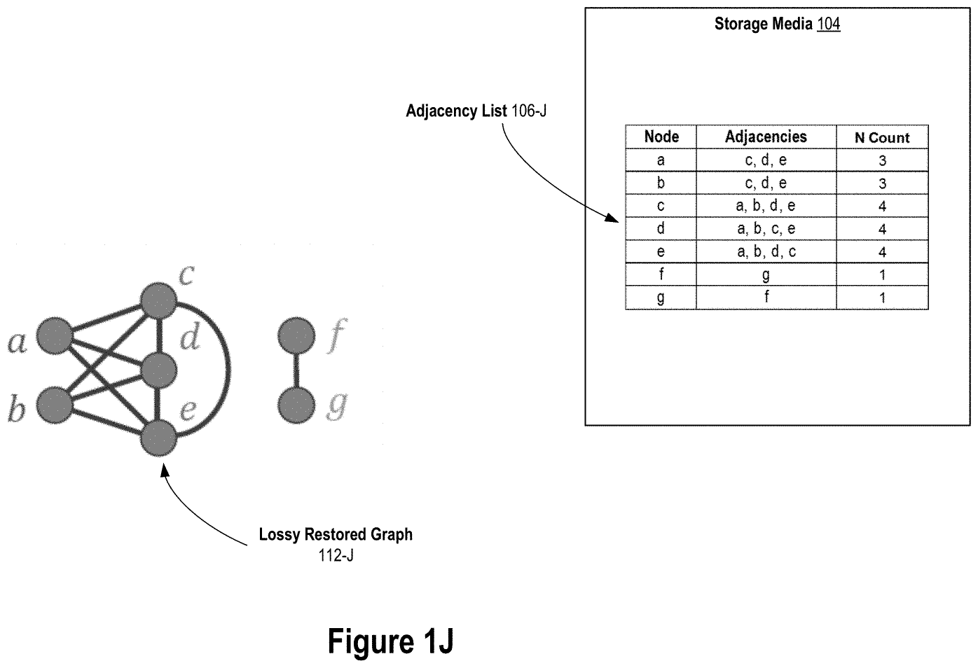

### Example Input Graph—FIG. 1A

FIG. 1A depicts an undirected input graph 102 and a corresponding adjacency list 106-A representation stored in storage media 104, according to some embodiments. The input graph 102 has seven (7) nodes and nine (9) edges. Each node is associated with a unique node identifier. In this example, for purposes of providing a clear example in this disclosure, the node identifiers of nodes in the input graph 102 are simple lower-case alphabet characters. However, a practical computer-based implementation may use more complex node identifiers such as for example 32, 64, or 128-bit values.

Each of the seven nodes of the input graph 102 is represented in the adjacency list 106-A by a corresponding node object of the adjacency list 106-A. The corresponding node object contains or refers to identifiers of the nodes that are neighbors (i.e., adjacencies) of the node for that node object. For example, the node object in the adjacency list 106-A for node ‘a’ indicates nodes ‘c’ and ‘e’ as neighbors (adjacencies) of node ‘a’ in the input graph 102. There is also a neighbor count of the node object that keeps a count of number of neighbors for each node of the input graph 102. It should be noted, however, that the neighbor count for a node can be derived by computationally counting the number of adjacencies of that node. Thus, there is no requirement that a node object maintain an express neighbor count.

It should also be noted that if the input graph 102 is directed, then it is possible for two nodes to be neighbors in one direction but not the other. For example, if the edge in input graph 102 between node ‘a’ to node ‘c’ was directed from node ‘a’ to node ‘c’, then node ‘c’ would be indicated as an adjacency of node ‘a’ in the adjacency list 106-A but node ‘a’ would not be indicated as an adjacency of node ‘c’ in the adjacency list 106-A.

It should also be noted that nodes may be connected by multiple edges (directed and undirected) in which case the adjacency list 106-A may have multiple node objects for the same node, or an edge object may specify all of the different types of edges that connect the two nodes.

### Summary Graph and Residual Graph

The reduced graph of an input graph produced by the lossless or lossy summarization processes disclosed herein may encompass two parts: a summary graph and a residual graph. The summary graph is smaller than the input graph in terms of number of edges and captures the important clusters and relationships in the input graph. The residual graph may be viewed as a set of corrections that can be used to recreate the input graph completely, if lossless summarization is applied, or within an error bound, if lossy summarization is applied.

With lossy summarization, further reduction in the size of the reduced graph can be realized within a selected error bound that represents a tradeoff between data storage size of the reduced graph and accuracy of the reduced graph in terms of the difference in edge structure between the input graph and a restored graph that is restored from the lossy reduced graph.

The summary graph may be viewed as an aggregated graph in which each node of the summary graph is referred to as a “supernode” and contains one or more nodes of the input graph. Each edge of the summary graph is referred to as a “superedge” and represents the edges in the input graph between all pair of nodes of the input graph of the corresponding supernodes connected by the superedge. The residual graph may contain a set of annotated edges of the input graph. Each edge is annotated as negative (‘−’) or positive (‘+’), as explained in greater detail below.

The summary graph can exploit the similarity of graph structure present in many graphs to achieve data storage savings. For example, because of link copying between web pages, web graphs often have clusters of nodes representing web pages with similar adjacency lists. Similarly, graphs representing social networks often contain nodes that are densely inter-linked with one another corresponding to different communities within the social network. With the graph structure similarity present in many graphs, nodes that have the same or similar set of neighbors in the input graph can be merged into a single supernode of the summary graph and the edges in the input graph to common neighbors can replaced with a single superedge, thereby reducing the number of edges that need to be stored when representing the summary graph as compared to the input graph.

The residual graph may be used to reconstruct the input graph from the summary graph either completely, or partially within an error bound, depending on whether lossless or lossy summarization is applied. Generally, an intermediate graph that is closer to (less a summary of) the input graph can be constructed from the summary graph by expanding the supernodes of the summary graph. In particular, for each supernode of the summary graph, the nodes of the supernode can be unmerged. And for each superedge of the summary graph, an edge can be added between all pairs of nodes of the supernodes connected by the superedge. However, with this expansion of the summary graph, it is possible that only a subset of these edges is actually present in the input graph. Further, it is also possible for an edge in the input graph is not represented in the summary graph. To correct for this, the residual graph is used. The residual graph contains a set of edge-corrections that are applied to the summary graph when expanding the summary graph. Specifically, for a superedge connecting supernodes in the summary graph where nodes x and y are at separate ends of the superedge, the residual graph may contain a “negative” entry of the form ‘−(x, y)’ for edges that are not present in the input graph between nodes x and y (where x and y are node identifiers of nodes of the input graph that were not connected by the edge). Where nodes x and y are connected by an edge in the input graph and there is no corresponding superedge between the corresponding supernodes in the summary graph, the residual graph may contain a “positive” entry of the form ‘+(x, y)’ for edges that are actually present in the input graph between nodes x and y (where x and y are node identifiers of nodes of the input graph that were connected by the edge).

Applying the residual graph to reconstruct the input graph is efficient since reconstructing each node in the input graph involves expanding just one supernode in the summary graph and applying the corresponding entries in the residual graph. An example of summarizing an input graph as a reduced graph and restoring the input graph from the reduced graph may aid understanding of the foregoing discussion.

### Example Lossless Summarization—FIG. 1B

Turning first to FIG. 1B, starting with input graph 102 and adjacency list 106-A of FIG. 1A, summary graph 108-B, residual graph 110-B, and adjacency list 106-B may be generated according to lossless graph summarization techniques disclosed herein. In particular, a summary graph is initialized to be the input graph 102 where each node of the input graph 102 is an initial supernode of the initial summary graph and each edge of the input graph 102 is an initial superedge of the initial summary graph.

Supernodes ‘a’ and ‘b’ of the initial summary graph are then merged as shown in summary graph 108-B of FIG. 1B. This merging is represented in the adjacency list 106-B with a node object for the supernode ‘{a, b}’. As such, the node object for supernode ‘{a, b}’ indicates the adjacencies of supernode ‘{a, b}’ in the summary graph 108-B. Note that by merging supernodes ‘a’ and ‘b’ into supernode ‘{a, b}’, separate node objects for supernodes ‘a’ and ‘b’ are not needed in adjacency list 106-B to represent the adjacencies of supernode ‘{a, b}’ in summary graph 108-B of FIG. 1B.

In addition, as a result of the merging, a residual graph 110-B is started with one entry representing that an edge between nodes ‘a’ and ‘d’ does not exist in the input graph 102 even though there is a superedge connecting supernodes ‘{a, b}’ and ‘d’ in summary graph 108-B. As such, a node object for node ‘a’ still exists in the adjacency list 106-B to represent this negative edge of the residual graph 110-B. The node object for node ‘d’ in adjacency list 106-B also represents the undirected negative edge. This negative edge is represented in the adjacency list 106-B of FIG. 1B with a ‘minus x’ notation where x is an identifier of a node of the input graph 102. However, other adjacency list representations of negative edges of a residual graph are possible and no particular adjacency list representation of a negatives edge of a residual graph is required.

It should be noted that the total number of edges in summary graph 108-B and residual graph 110-B is eight (8), which is less than the total number of edges (9) in input graph 102. As such, the portion of storage media 104 occupied by adjacency list 106-B may be less (fewer bytes) than the portion occupied by adjacency list 106-A of FIG. 1A.

### Example Lossless Summarization—FIG. 1C

Turning now to FIG. 1C, starting with summary graph 108-B, residual graph 110-B, and adjacency list 106-B of FIG. 1B, summary graph 108-C, residual graph 110-C, and adjacency list 106-C may be generated according to lossless graph summarization techniques disclosed herein. In particular, supernodes ‘c’, ‘d’, and ‘e’ of summary graph 108-B are merged. This merging is represented in the adjacency list 106-C with a node object for the supernode ‘{c, d, e}’ that replaces the separate node objects for supernodes nodes ‘c’, ‘d’, and ‘e’ in adjacency list 106-B of FIG. 1B. This replacement is for purposes of representing adjacencies in the summary graph 108-C. As such, the node object for supernode ‘{c, d, e}’ indicates the adjacencies of supernode ‘{c, d, e}’ in the summary graph 108-C.

In addition, as a result of the merging, a new residual graph 110-C is generated by adding two entries to prior residual graph 110-B as reflected in adjacency list 106-C. First entries in adjacency list 106-C represent that an edge between nodes ‘c’ and ‘e’ does not exist in the input graph 102 even though supernode ‘{c, d, e}’ is adjacent (connected) to itself by a “self” superedge in summary graph 108-C. A self “superedge” in a summary graph, like the one of summary graph 108-C that connects supernode ‘{c, d, e}’ to itself, represents that every pair of nodes of the supernode is connected in the summary graph. For example, the self supernode connecting supernode ‘{c, d, e}’ to itself represents that nodes ‘c’ and ‘d’, ‘c’ and ‘e’, and ‘d’ and ‘e’ are connected in summary graph 108-C.

Second entries in adjacency list 106-C represent that an edge between nodes ‘d’ and ‘g’ does exist in the input graph 102 even though there is no superedge in summary graph 108-C connecting supernodes ‘{c, d, e}’ and ‘g’. This positive edge is represented in the adjacency list 106-C with a ‘plus x’ notation where x is an identifier of a node of the input graph 102. However, other adjacency list representations of positive edges of a residual graph are possible and no particular adjacency list representation of a positive edge is required.

It should be noted that by merging supernodes, the data storage size of the adjacency list representation of the summary graph and the residual graph is reduced. For example, by merging supernodes ‘c’, ‘d’, and ‘e’ of summary graph 108-B as reflected in summary graph 108-C, the total number of adjacencies that are represented by adjacency list 106-C as a result of the merging is less than the total number of adjacencies that are represented by adjacency list 106-B before the merging. In particular, the total number of adjacencies is reduced from sixteen (16) in adjacency list 106-B to eleven (11) in adjacency list 106-C.

### Example Lossless Summarization—FIG. 1D

Turning now to FIG. 1D, starting with summary graph 108-C, residual graph 110-C, and adjacency list 106-C of FIG. 1C, summary graph 108-D, residual graph 110-D, and adjacency list 106-D may be generated according to lossless graph summarization techniques disclosed herein. In particular, supernodes ‘f’ and ‘g’ of summary graph 108-C are merged in summary graph 108-D. This merging is represented in the adjacency list 106-D with a node object for the supernode ‘{f, g}’ that replaces the separate node objects for supernodes ‘f’ and ‘g’ in adjacency list 106-C of FIG. 1C. This replacement is for purposes of representing adjacencies in the summary graph 108-D. As such, the node object for supernode ‘{f, g}’ indicates the adjacencies of supernode ‘{f, g}’ in the summary graph 108-D. Despite the replacing, node objects for supernodes ‘g’ and ‘d’ still exist in adjacency list 106-D to represent the undirected positive edge ‘+(d, g)’ of the residual graph 110-D.

### Example Lossless Restoration—FIG. 1E

As mentioned, an input graph that is losslessly summarized as a reduced graph according to lossless graph summarization techniques disclosed herein can be completely restored by reversing the lossless graph summarization steps. For example, the input graph 102 of FIG. 1A may be completely restored from the summary graph 108-D and residual graph 110-D of FIG. 1D by reversing the lossless graph summarization steps depicted in FIG. 1D, FIG. 1C and FIG. 1B.

Turning now to FIG. 1E, the lossless graph summarization step depicted in FIG. 1D is reversed by expanding supernode ‘{f, g}’ resulting in summary graph 108-E and adjacency list 106-E where supernodes ‘f’ and ‘g’ are separate supernodes in summary graph 108-E. As a result, the node object in adjacency list 106-D for supernode ‘{f, g}’ of summary graph 108-D is replaced for adjacency purposes by separate node objects for supernodes ‘f’ and ‘g’ in adjacency list 106-E.

### Example Lossless Restoration—FIG. 1F

Turning now to FIG. 1F, the lossless graph summarization step depicted in FIG. 1C is reversed by expanding supernode ‘{c, d, e}’ of summary graph 108-E and applying negative entry ‘−(c, e)’ and the positive entry ‘+(d, g)’ of residual graph 110-E resulting in summary graph 108-F, residual graph 110-F, and adjacency list 106-F.

### Example Lossless Restoration—FIG. 1G

Turning now to FIG. 1G, the lossless graph summarization step depicted in FIG. 1B is reversed by expanding supernode ‘{a, b}’ of summary graph 108-F and applying negative entry ‘−(a, d)’ of residual graph 110-F resulting in lossless restored graph 112-G and adjacency list 106-G.

### Example Lossly Summarization—FIG. 1H

In the graph summarization depicted in FIG. 1B, FIG. 1C, and FIG. 1D, the graph summarization is lossless. That is, the input graph 102 of FIG. 1A can be completely restored from the summary graph 108-D and the residual graph 110-D of FIG. 1D. The data storage savings in terms of number of edges of input graph 102 of FIG. 1A (nine (9) edges) versus the number of edges in summary graph 108-D and residual graph 110-D of FIG. 1D (six (6) edges) is three (3) edges.

Lossy summarization within an error bound constraint may further be applied to a summary graph and a residual graph to achieve further edge savings. The error bound constraint may be for example that a graph restored from a lossy reduced graph must satisfy both of the following conditions: (1) first, each node in the input graph must be in the lossy restored graph, and (2) second, for each node in the lossy restored graph, the number of nodes in the symmetric difference (disjunctive union) between the node's adjacencies in the lossy restored graph and the node's adjacencies in the input graph is at most a predetermined percentage of the number of the node's adjacencies in the input graph. In some embodiments, the predetermined percentage is 50%. By adhering to this error bound constraint, a degree of accuracy of the edge structure of the lossy restored graph relative to the edge structure of the input graph is ensured.

Turning now to FIG. 1H, starting with summary graph 108-D, residual graph 110-D, and adjacency list 106-D, the three edges of residual graph 110-D of FIG. 1D are dropped within an error bound constraint resulting in residual graph 110-H (an empty graph). Summary graph 108-H is the same as summary graph 108-D of FIG. 1D. As a result, an additional three (3) edges are saved for a total of six (6) edges saved relative to the input graph 102 of FIG. 1A. The number of node objects in the adjacency list 106-H is also reduced relative to the number of node objects in the adjacency list 110-D as a result of dropping the edges of the residual graph 110-D, thereby reducing the amount of data storage space (e.g., in bytes) of storage media 104 required to store adjacency list 106-H relative to adjacency list 110-D.

### Example Lossy Restoration—FIG. 1J

Turning now to FIG. 1J, it shows a lossy restored graph 112-J that is restored from summary graph 108-H and residual graph 110-H of FIG. 1H. Because the edges of residual graph 110-D of FIG. 1D are dropped in residual graph 110-H, the lossy restored graph 112-J contains an edge connecting nodes ‘a’ and ‘d’ and contains an edge connecting nodes ‘c’ and ‘e’. These edges are not contained in the input graph 102 of FIG. 1A. In addition, the restored graph 112-J does not contain an edge connecting nodes ‘d’ and ‘g’ that is contained in the input graph 102 of FIG. 1A. Thus, with lossy summarization, accuracy in the lossy restored graph is sacrificed for greater edge savings (and hence greater data storage savings) in the lossy reduced graph.

In the example of FIG. 1J, the error bound constraint is 0.5 (50%), and for each node in the lossy restored graph 112-J, the number of nodes of the symmetric difference (disjunctive union) between the node's adjacencies in the lossy restored graph 112-J and the node's adjacencies in the input graph 102 of FIG. 1A is at most half of the number of the node's adjacencies in the input graph.

With the foregoing examples in mind, the lossless and lossy graph summarization processes will now be described in greater detail.

### Graph Summarization Process

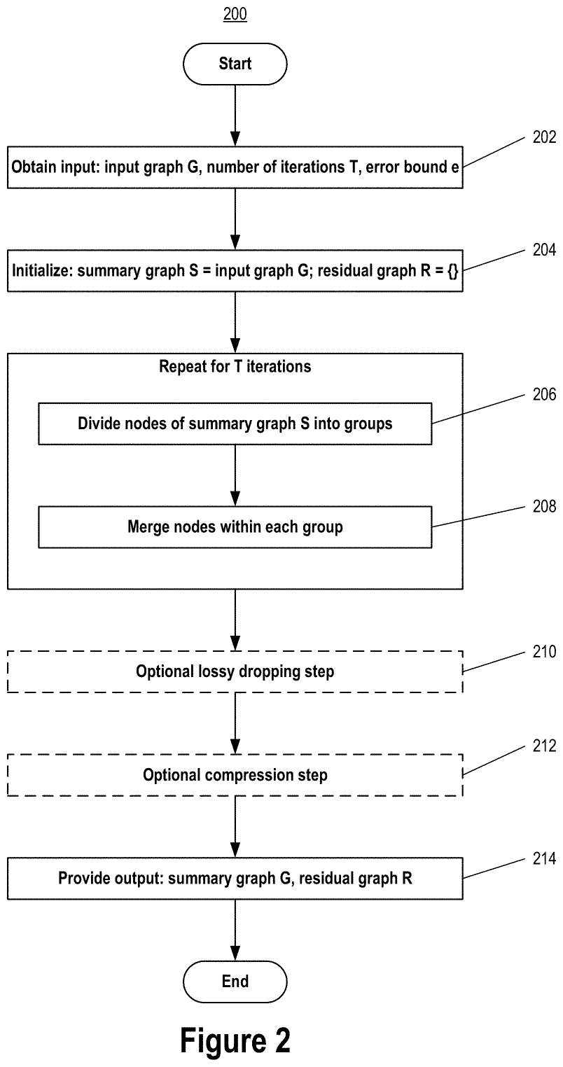

FIG. 2 depicts an example graph summarization process 200, according to some embodiments. The process 200 includes the general steps of obtaining input 202, initializing 204 internal process parameters, and repeating for a number of iterations, a dividing step 206 and a merging step 208. The steps 202 through 208 encompass a lossless summarization process. Step 210 is an optional additional lossy dropping step that may be performed for lossy summarization. In either case, the resulting reduced graph can be compressed 212 using a known graph-compression algorithm (e.g., run-length encoding). Finally, the resulting reduced graph is provided 214 as output where the reduced graph is either lossless or lossy depending on whether the optional lossy dropping step 210 is performed and includes a summary graph and a residual graph.

Returning to the top of process 200, input parameters to the process are obtained 202. The input parameters obtained 202 may include a reference to an input graph G to be summarized. The input parameters obtained 202 may also include a maximum number of iterations T to which to perform the dividing step 206 and the merging step 208. If the lossy summarization step 210 is performed, then an error bound e may also be obtained 202 among the input parameters.

Default values for the number of iterations T and/or the error bound e may also be used if the maximum number of iterations T and/or the error bound e is/are not obtained 202 as part of the input parameters. In some embodiments, the default number of iterations T is twenty (20) and the default error bound e is 0.50. The use of the maximum number of iterations T and the error bound e is explained in greater detail below.

In some embodiments, the process 200 in configured by default to perform lossless summarization (steps 202 through 208) with the compressing step 212 applied to the lossless reduced graph produced by lossless summarization without performing the lossy summarization dropping step 210. However, in these embodiments, the process 200 may perform the lossy summarization dropping step 210 if the input parameters obtained 202 include a value for the error bound e. In addition, the compressing step 212 may be applied to the lossy reduced graph produced by the lossy summarization step 210.

At step 204, a summary graph S is initialized to be the input graph G and a residual graph R is initialized to be an empty graph. When initializing 204 the summary graph S, each node in the input graph G becomes a supernode in the summary graph S containing the one node of the input graph G. Each edge of the input graph G becomes a superedge in the summary graph S connecting the supernodes corresponding to the nodes of the input graph G connected by the edge.

Note that this initializing 204 does not require creating a separate copy of the adjacency list representation of the input graph G (although that is not prohibited) and the adjacency list representation of the input graph G can be used to represent the initial summary graph S where each node object in the adjacency list represents a supernode of the initial summary graph S. Further, adjacency list entries for supernodes of the summary graph S and for negative and positive edges of the residual graph R can be stored in a separate adjacency list or lists without modifying the adjacency list representing the input graph G. As such, after performing process 200 on input graph G, the adjacency list representing the input graph G may be unmodified by the process 200. However, a new separate adjacency list or lists representing the summary graph S and residual graph R of the lossless or lossy reduced graph produced as a result of performing process 200 on input graph G may be generated.

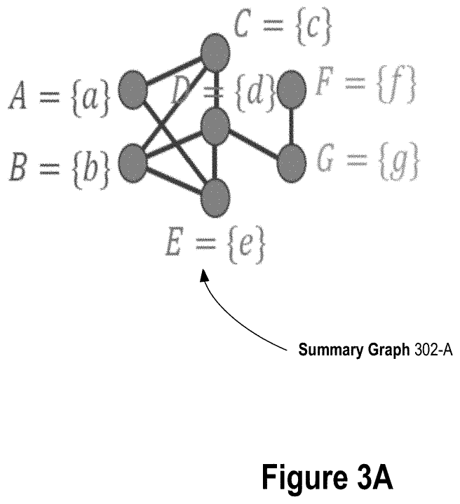

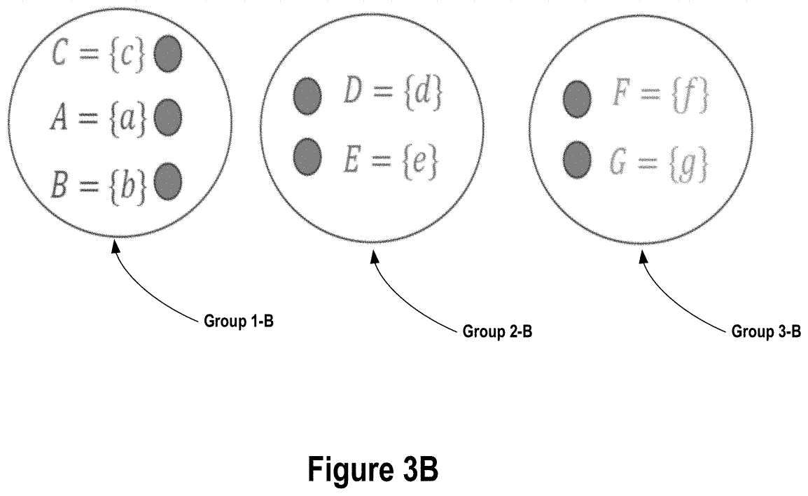

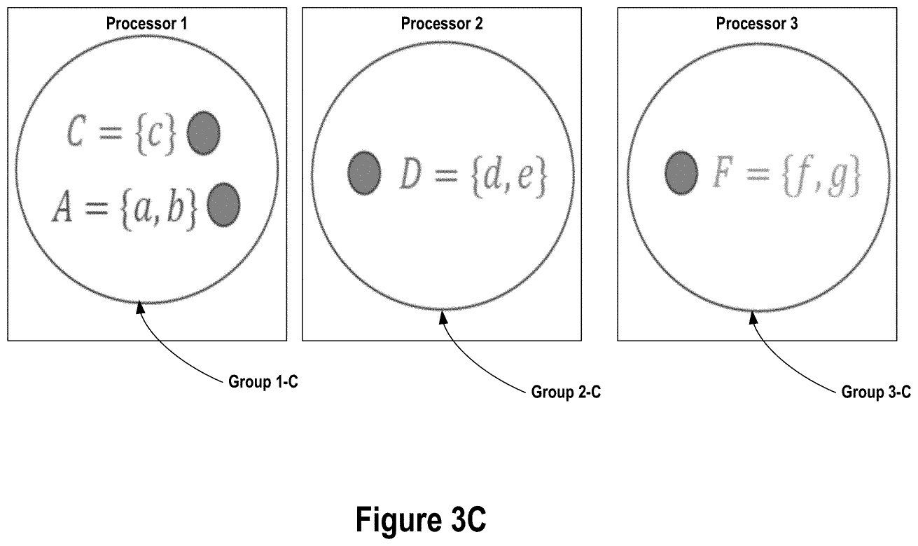

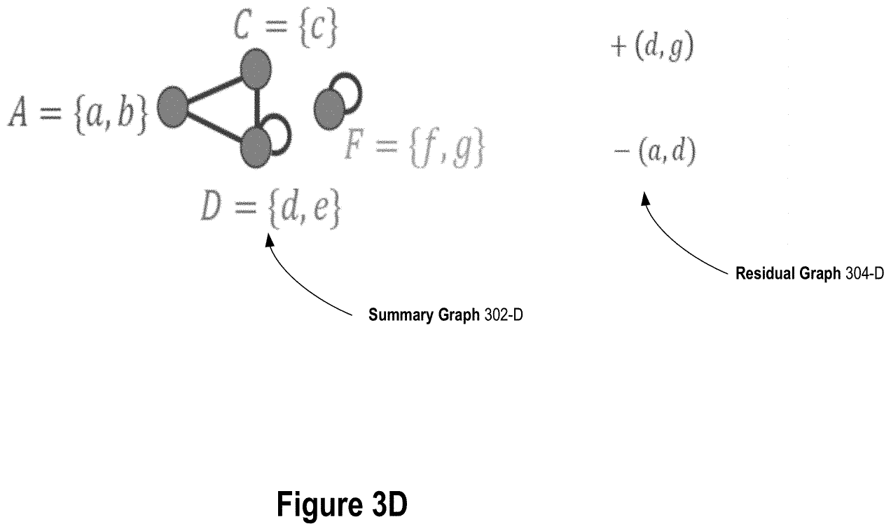

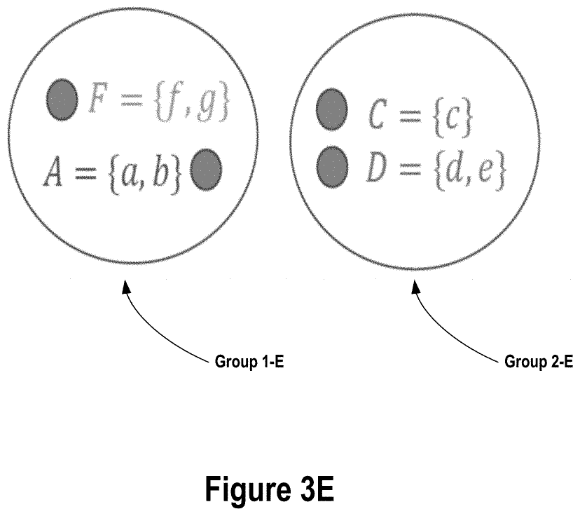

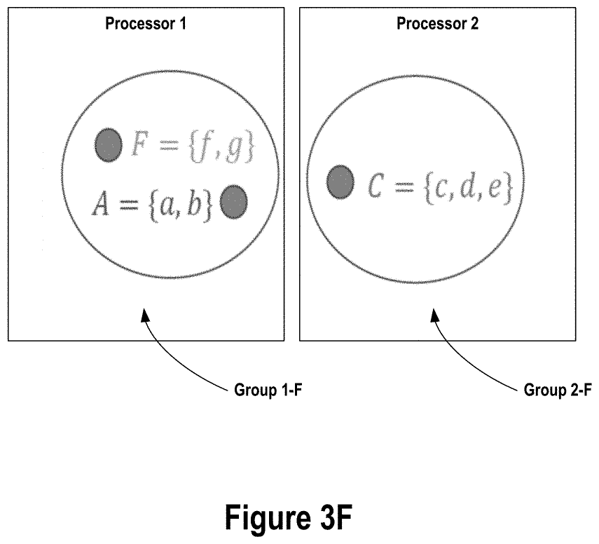

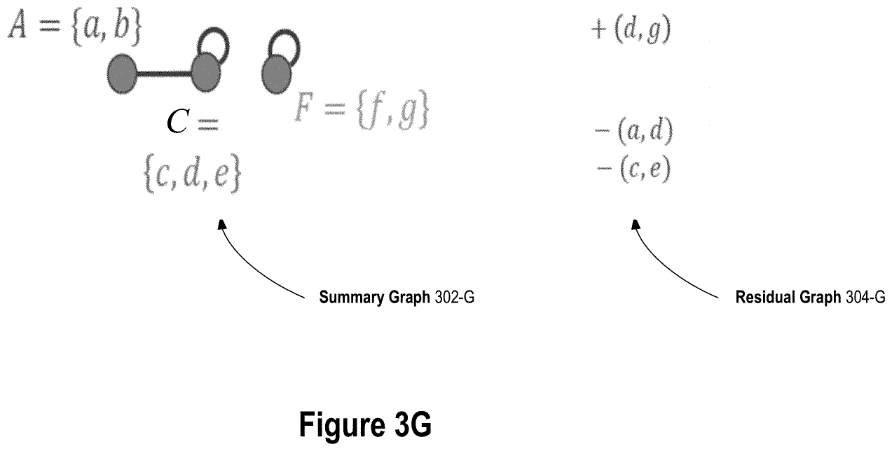

### Example Initialization—FIG. 3A

For example, FIG. 3A depicts a summary graph 302-A initialized based on input graph 102 of FIG. 1A. In summary FIG. 3A, each supernode of summary graph 302-A corresponds to one node of the input graph 102. Supernodes of summary graph 302-A are depicted in FIG. 3A with unique capital alphabet letters for purposes of providing a clear example in this disclosure. However, a practical computer-based implementation may use more complex supernode identifiers such as for example 32, 64, or 128-bit values.

### Dividing and Merging Overview

After initializing 204, the dividing step 206 and the merging step 208 are performed together for a number of iterations. Each performance of the dividing step 206 and the merging step 208 together is on the current lossless reduced graph which encompasses the current summary graph S and the current residual graph R. Initially, the current summary graph S is initialized based on the input graph G and the current residual graph R is initialized to be an empty graph, as described above with respect to step 204. Then, steps 206 and 208 are repeatedly performed on the current summary graph S and the current residual graph R. For each iteration of steps 206 and 208 together, a new current summary graph S and a new current residual graph R are generated. After the last iteration of steps 206 and 208, the then current summary graph S and the then current residual graph R become the result of the lossless graph summarization steps 202 through 208.

Returning to steps 206 and 208, the supernodes of the current summary graph S are iteratively divided into groups. Candidate supernodes within each group are then identified based on heuristically estimated edge savings. Identified candidate supernodes within a group are then merged if merging the identified candidate supernodes achieves at least threshold amount of savings in terms of the reduction in the number of edges in the current lossless reduced graph from without the candidate supernodes merged in the current summary graph compared to with the candidate supernodes merged.

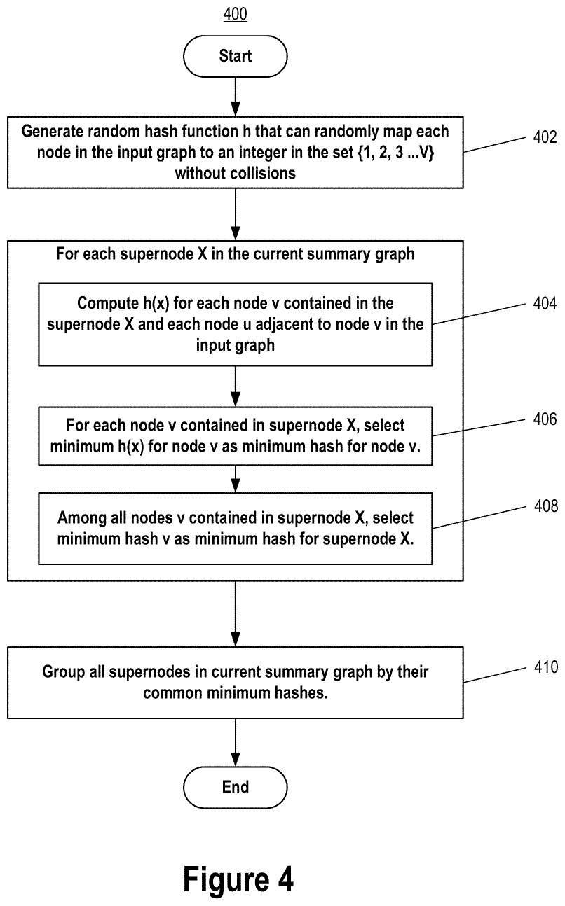

The dividing step 206 is explained in greater detail below with respect to FIG. 4. Significantly, however, the dividing step 206 can be performed without having to store an adjacency list representation of the entire input graph G in-memory at once, thereby improving graph summarization computer systems. Briefly, this is made possible because the group to which a supernode of the current summary graph S belongs can be determined by the dividing step 206 independent of other supernodes from just the node objects of the adjacency list for the input graph G for the nodes of the input graph G that belong to the supernode. Thus, only a certain small portion the adjacency list for the input graph G need be stored in in-memory at once for each supernode of the current summary graph S in order to perform the dividing step 206 for the supernode. Further, this independence of other supernodes allows the dividing step 206 to be performed in parallel for multiple supernodes, thereby improving graph summarization computer systems.

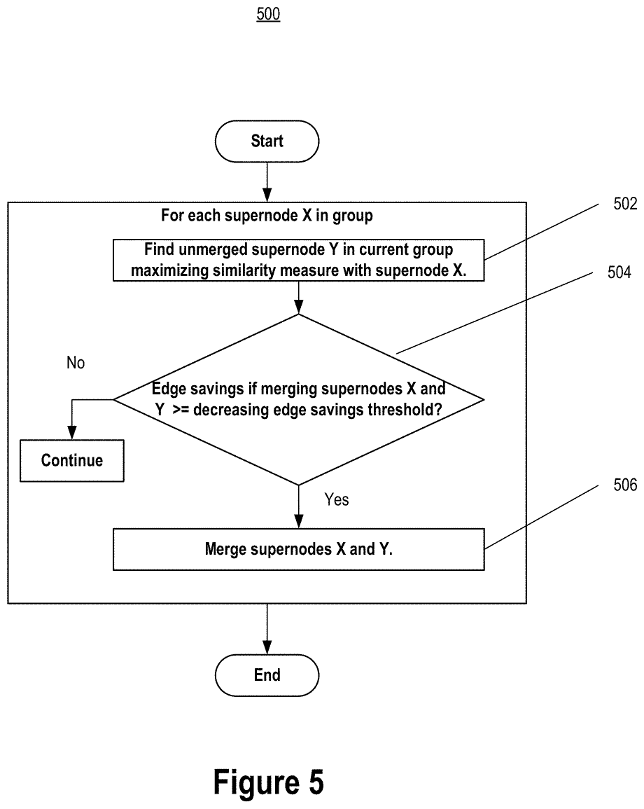

The merging step 208 is explained in greater detail below with respect to FIG. 5. Like the dividing step 206, the merging step 208 can be performed without having to store an adjacency list representation of the entire input graph G in-memory at once, thereby improving graph summarization systems. Briefly, when identifying supernodes of the current summary graph S to merge 208, the merging step 208 searches for such candidate nodes only within each of the groups that result from the preceding dividing step 206. Because of this intra-group only searching for candidates to merge, the merging step 208 can be performed on multiple groups in parallel in a parallel processing manner, thereby improving graph summarization systems.

### Example Dividing Step—FIG. 3B

For example, starting with a current summary graph initialized at step 204 such as for example summary graph 302-A of FIG. 3A that is initialized based on input graph 102 of FIG. 1A, FIG. 3B depicts how the dividing step 206 might group the supernodes of the summary graph 302-A during a first iteration of the dividing 206 step. In particular, Group 1-B contains supernodes ‘C’, ‘A’, and ‘B’ of summary graph 302-A; Group 2-B contains supernodes ‘D’ and ‘E’ of summary graph 302-A; and Group 3-B contains supernodes ‘F’ and ‘G’ of summary graph 302-A.

Significantly, as explained in greater detail below with respect to FIG. 4, the dividing step 206 can assign a supernode to a group based on just the nodes contained by the supernode and their adjacencies in the input graph G. For example, the dividing step 206 can assign supernode ‘A’ of summary graph 302-A to Group 1-B based on just the node object from the adjacency list 106-A for the input graph 102 for node ‘a’. This is similar for the other supernodes of the summary graph 302-A. As a result, only a very small portion of the adjacency list of the input graph G is required to be stored in-memory at once in order for the dividing step 206 to assign a given supernode of the current summary graph to a group of supernodes.

### Example Merging Step—FIG. 3C

Continuing the example, FIG. 3C depicts the result of the merging step 208 after the result of the preceding dividing step 206 as shown in FIG. 3B. Here, the merging step 208 is performed in parallel across three processors. However, it is also possible to use a few as two processors or more than three processors. For example, if there were only Processor 1 and Processor 2 available to the merging step 208 and Processor 3 were not available to the merging step 208, then two of the three groups could be processed by the merging step 208 in parallel and then when processing of one of those groups completes, the remaining group could be processed by the merging step 208 on the now empty processor. In this example, if there were more than three processors available to the merging step 208, then some of the processors may be unused for the merging step 208.

The merging step 208 at Processor 1 operates in parallel on Group 1-B of FIG. 3B to produce Group 1-C of FIG. 3C. The merging step 208 at Processor 2 operates in parallel on Group 2-B of FIG. 3B to produce Group 2-C of FIG. 3C. The merging step 208 at Processor 3 operates in parallel on Group 3-B of FIG. 3B to produce Group 3-C of FIG. 3C. The result of the merging step 208 at Processor 1 is that supernodes ‘A’ and ‘B’ are merged together into supernode ‘A’ that contains nodes ‘a’ and ‘b’ of the input graph 102. As explained in greater detail below with respect to FIG. 5, the merging step 208 can merge supernodes within a group (e.g., Group 1-C) without requiring access to adjacency list node objects for nodes of the input graph that do not belong to supernodes of the group (e.g., nodes ‘d’, ‘e’, ‘f’, and ‘g’ of the input graph in the supernodes of Groups 2-C and 3-C), thereby facilitating the parallelization of the merging step 208 and improving both computational time performance and data storage performance of graph summarization systems.

Continuing the example, supernodes ‘D’ and ‘E’ are merged at Processor 2 by the merging step 208 into supernode ‘D’ that contains nodes ‘d’ and ‘e’ of the input graph.

And supernodes ‘F’ and ‘G’ are merged at Processor 3 by the merging step 208 into supernode ‘F’ that contains nodes ‘f’ and ‘g’ of the input graph. After the merging depicted in FIG. 3C, one iteration of the dividing 206 and merging 208 steps is complete.

### Example Lossless Reduced Graph—FIG. 3D

Continuing the example, FIG. 3D shows the current summary graph 302-D and the current residual graph 304-D after one iteration of the dividing 206 and merging 208 steps starting with the summary graph 302-B of FIG. 3B. As can be seen, the current summary graph 302-D and the current residual graph 304-D reflect the dividing 206 and merging 208 results depicted in FIG. 3B and FIG. 3C, respectively.

### Example Dividing Step—FIG. 3E

Continuing the example, FIG. 3E depicts a second iteration of the dividing step 206 this time operating on current summary graph 302-D of FIG. 3D. A result of the second iteration of the dividing step 206, supernodes ‘F’ and ‘A’ of current summary graph 302-D are assigned to Group 1-E and supernodes ‘C’ and ‘D’ of current summary graph 302-D are assigned to a different Group 2-E. Once again, the dividing step 206 can assign a supernode to a group with only a portion of the input graph. For example, the dividing step 206 can assign supernode ‘F’ to Group 1-E based on just the adjacency list node objects for nodes ‘f’ and ‘g’ of the input graph. Furthermore, because the dividing step 206 can assign supernodes to groups independent of other supernodes, the dividing step 206 can assign supernodes to groups in parallel with each other, thereby improving graph summarization systems. For example, the dividing step 206 can assign each of supernodes ‘A’, ‘C’, ‘D’, and ‘F’ to groups independently of each other and in parallel with each other.

### Example Merging Step—FIG. 3F

Continuing the example, FIG. 3F depicts the result of the second iteration of the merging step 208 performed after the second iteration of the dividing step 206. In this example, the second iteration of the merging step 208 is performed in parallel on Group 1-E and Group 2-E of FIG. 3E resulting from the second iteration of the dividing step 206 across two processors. As a result, the merging step 208 determines not to merge supernodes ‘F’ and ‘A’ of Group 1-E of FIG. 3E because it is determined that there would not be at least a threshold edge savings if merged. On the other hand, the merging step 208 does determine to merge supernodes ‘C’ and ‘D’ of Group 2-E of FIG. 3E because it is determined that there would be at least a threshold edge savings if merged. Once again, the merging step 208 can make these determinations for a group based on just the nodes of the group without access to adjacency list information about nodes in other groups, thereby facilitating the parallelization of the merging step 208 and improving both computational time performance and data storage performance of graph summarization systems.

### Example Lossless Reduced Graph—FIG. 3G

Continuing the example, FIG. 3G depicts the lossless reduced graph after the second iteration of the dividing step 206 and the merging step 208 are complete. The lossless reduced graph includes summary graph 302-G and residual graph 304-G.

### Dividing Step Process

Turning now to FIG. 4, it depicts an example process 400 for the dividing step 206 of process 200, according to some embodiments. Process 400 may be performed for each iteration of the dividing step 206 as part of process 200 discussed above with respect to FIG. 2.

The overall goal of process 400 is to assign each supernode of the current summary graph S to a group of similar supernodes in an efficient manner where each group contains similar supernodes in terms of common adjacencies in the input graph G of the nodes contained in the supernodes. As mentioned previously, process 400 can do this assigning for each supernode independently of other supernodes. Because of this independence, only a certain small portion of the adjacency list representation of the input graph G needs to be stored in-memory at once. Also because of this independence, the assignment of supernodes to groups can be performed in parallel, thereby improving the computational time performance of process 400 and consequently containing process 200.

For each iteration of the dividing step 206, a different random hash function h is generated 402 to reduce variance. The generated random hash function h has the property that it can efficiently and randomly map each node of the input graph to a different integer in a set of integers without collisions. For example, the set of integers may be all integers from 0 to V−1 inclusive, or all integers from 1 to V inclusive, where V is the total number of nodes of the input graph. A suitable random hash function can be created by (a) randomly shuffling the order of the nodes in the input graph and (b) assigning each i-th node to i. Different random hash functions can be generated by shuffling nodes differently at each iteration of the dividing step 206 such as for example by using a pseudo-random number generator at each iteration to create a different random shuffling of the order of nodes of the input graph.

Next, steps 404, 406, and 408 are performed for each supernode in the current summary graph S. This computation can be performed independently for each supernode and thus can be parallelized. Further, in order to perform steps 404, 406, and 408 for a supernode just the adjacency list node objects for the nodes of the input graph contained in the supernode are needed.

At step 404, the random hash function h generated at step 402 is applied to each node v and to each node u adjacent to node v contained in the current supernode X. For example, if the input graph G is input graph 102 of FIG. 1A, the current summary graph S is summary graph 302-D of FIG. 3D, and the current supernode X of process 400 is supernode ‘D’ of summary graph 302-D (containing nodes ‘d’ and ‘e’ of input graph 102), then at step 404, h(x) would be computed for node ‘d’ and for each adjacency x of node ‘d’ in the input graph 102 and h(x) would be computed for node ‘e’ and for each adjacency x of node ‘e’ in the input graph 102. Specifically, h(‘a’), h(‘b’), h(‘c’), h(‘d’), h(‘e’), and h(‘g’) would each be computed. Note that to perform this computation, only the node objects of the adjacency list 106-A for nodes and ‘e’ are needed and no other node objects of the adjacency list 106-A are needed.

At step 406, for each node v contained in the current supernode X, the minimum h(u) computed in step 404 for the node v is selected as the minimum hash for the node v. Returning to the previous example, among h(‘b’), h(‘c’), h(‘d’), h(‘e’), and h(‘g’), the minimum of those numerically is selected as the minimum hash for node ‘d’. Similarly, among h(‘a’), h(‘b’), h(‘d’), and h(‘e’), the minimum of those numerically is selected as the minimum hash for node ‘e’.

At step 408, the minimum hash v among all nodes contained in the current supernode X is selected as the minimum hash for supernode A. Again, returning to the previous example, the minimum of (1) the minimum hash selected for node ‘d’ at step 406 and (2) the minimum hash selected for node ‘e’ at step 406 would be selected as the minimum hash for the current supernode ‘D’ of current summary graph 302-D.

Steps 402 through 408 are repeated for each supernode in the current summary graph S resulting in a minimum hash efficiently computed for each supernode.

At step 410, the supernodes of the current summary graph are grouped by their common minimum hashes as computed in steps 404 through 408 such that all supernodes in the same group have the same minimum hash and the number of distinct groups is equal to the number of distinct minimum hashes computed for all supernodes of the current summary graph. The result of the grouping is that supernodes with the same or similar adjacencies are grouped together in the same group. Process 400 is computationally efficient because it does not require storing all adjacency list nodes objects for nodes in the input graph G in-memory at once and because computing minimum hash values for each supernode of the current summary graph G can be computed independently of each other and in parallel with one another.

It should be noted that while process 400 as described above involves computing minimum hashes, one skilled in the art will appreciate that process 400 could involve computing maximum hashes instead of minimum hashes in a likewise fashion without loss of generality.

### Merging Step Process

Turning now to FIG. 5, it depicts an example merging step process 500 for the merging step 208 of process 200, according to some embodiments. Process 500 may be performed for each iteration of the merging step 208 after the dividing step 206 is performed in the current iteration as part of process 200 discussed above with respect to FIG. 2.

Process 500 may be performed for each group of supernodes resulting from the preceding dividing step 206. More specifically, the steps of process 500 may be performed for each supernode within a group of supernodes determined by the preceding dividing step 206. Process 500 is designed such that it may be performed in parallel on each group of supernodes determined by the preceding dividing step 206, thereby improving the computational efficiency of process 500 and consequently process 200.

For each supernode X in a target group of supernodes on which the merging process 500 is operating, process 500, at step 502, finds an unmerged supernode Y in the target group that maximizes a supernode adjacency similarity measure between supernodes X and Y among all as yet unmerged supernodes in the target group that have not already been merged with another supernode in the target group during the current iteration of the merging step 208. Note that supernode Y in the current iteration of the merging step 208 may be the result of merging supernodes together in a prior iteration of the merging step 208. Thus, supernode Y is “unmerged” in that is has not yet been merged with another supernode in the target group during the current iteration of the merging step 208. Finding supernode Y in the target group that maximizes the supernode adjacency similarity measure with supernode X of the target group may be performed by computing the supernode adjacency similarity measure between X and every other supernode in the target group that has not yet been merged during the current iteration of the merging step 208 and then selecting the supernode Y that is most similar to supernode A according to the supernode adjacency similarity measure.

To identify a candidate supernode Y to potentially merge with a given supernode X in a group, a computationally efficient supernode adjacency similarity measure may be used as opposed to computing the actual edge savings that would be realized if supernodes X and Y were merged. One computationally efficient supernode adjacency similarity measure that may be used is the Jaccard similarity which may be computed as

$$\vert \frac{W ⋂ Z}{W ⋃ Z} \vert .$$

Here, W may the union of all distinct nodes in the input graph that are adjacent (neighbors of) at least one node contained in one of the supernodes (X or Y) and Z may be the union of all distinct nodes in the input graph at are adjacent to (neighbors of) at least one node contained in the other of the supernodes (X or Y). One skilled in the art will appreciate that other computationally efficient supernode adjacency similarity measures such as the cosine similarity

$$( e . g . , \frac{W \cdot Z}{‖ W ‖ ‖ Z ‖} )$$

may be used in a similar fashion.

At step 504, after a supernode Y is identified as a candidate for merging with current supernode X, the supernodes X and Y are not merged unless the edge savings in the reduced graph from merging the supernodes X and Y would be below an edge savings threshold. The edge savings by merging supernodes X and Y may be computed as follows:

$$Savings ( X , Y ) = 1 - \frac{Cost ( X , Y )}{Cost ( X ) + Cost ( Y )}$$

Here, Cost(X, Y) is the cost of merging X and Y in terms of the total number of edges adjacent to supernode X merged with supernode Y that would exist in the current summary graph S and the current residual graph R if X and Y were to be merged in the current summary graph S. The Cost(X) is the number of edges adjacent to supernode X in the current summary graph S and the current residual graph R. The Cost(B) is the number of edges adjacent to supernode Y in the current summary graph S and the current residual graph R. Thus, the edge Savings(X, Y) is negative if the Cost(X, Y) of merging supernodes X and Y is greater than the Cost(X)+Cost(Y) of not merging supernodes X and Y. The edge Savings(X, Y) is zero if the Cost(X, Y) of merging supernodes X and Y is the same as the Cost(X)+Cost(Y) of not merging supernodes X and Y. And the edge Savings(X, Y) is positive if the Cost(X, Y) of merging supernodes X and Y is less than the Cost(X)+Cost(Y) of not merging supernodes X and Y.

At step 504, candidate supernodes X and Y may be merged if the edge Savings(X, Y) is greater than or equal to a decreasing edge savings threshold where the decreasing edge savings threshold is a function of the number of number of iterations of the merging step 208 performed so far during a performance process 200. For example, supernodes X and Y may be merged if the edge Savings(A, B) is greater than or equal to

$$\{ \begin{matrix}{( 1 + t )}^{- 1} , & if t < T \\ 0 & if t = T\end{matrix} ,$$

where the parameter t represents the number of the current iteration of the merging step 208 during the performance of process 200. For example, parameter t may be initialized to one before the first iteration of merging step 208 during the performance process 200 and increased by one after each iteration of the merging step 208 during the performance of process 200. As a result, the edge savings threshold decreases over iterations of the dividing step 206 and the merging step 208 during the performance of process 200. During the earlier iterations of the merging step 208 during the performance of process 200 when parameter t is relatively smaller in numerical value, there must be relatively more possible edge Savings(X, Y) in order for two candidate supernodes X and Y to be merged. This relatively greater edge savings threshold allows for relatively more exploration of supernodes in other groups during the earlier iterations of the dividing step 208 and the merging step 208 during the performance of process 200. On the other hand, when parameter t is relatively larger numerically during the later iterations of the dividing step 208 and the merging step 208 during the performance of process 200, there can be relatively less edge Savings(X, Y) for two candidate supernodes X and Y and they will still be merged. This relatively smaller edge savings threshold allows for relatively more exploitation within each group during the later iterations of the dividing step 208 and the merging step 208 during the performance of process 200. A result of decreasing the edge savings threshold as the number of iterations increases during the performance of process 200 is that merges of supernodes with relatively greater edge savings are prioritized providing greater summarization of the input graph, when compared to maintaining a constant edge savings threshold across iterations. This greater summarization results in a smaller data storage size of the reduced graph when compared to maintaining a constant edge savings threshold across iterations during the performance of process 200.

It should be noted that while the dividing step 206 and the merging step 208 during a performance of process 200 can be performed for up to a maximum number T of iterations, fewer than T iterations may be performed based on determining that further substantial edge savings would not be realized by performing more iterations. For example, process 200 may stop repeating the dividing step 206 and the merging step 208 after N less than T iterations if at the merging step 208 of the Nth iteration no supernodes are merged. Other early termination conditions are possible such as no supernodes are merged by the merging step 208 for some number (e.g., 2) of consecutive iterations, or less than a predetermined threshold number of supernodes are merged by the merging step 208 for some number of consecutive iterations, or the total edge savings realized by the latest merging step 208 is less than a predetermined threshold, or less than the predetermined threshold for some number of consecutive iterations.

### Lossy Dropping Step

As a result of performing process 200 of FIG. 2 including performing the diving step 206 and the merging step 208 for one or more iterations, a lossless reduced graph is produced. The lossless reduced graph encompasses a summary graph S and a residual graph R where preferably the total number of edges between the summary graph S and the residual graph R is less than the total number of edges of the input graph and yet the input graph can be completely restored from the lossless reduced graph. The optional lossy dropping step 210 may be performed on the lossless reduced graph to produce a lossy reduced graph that has even fewer edges than the lossless reduced graph but with a sacrifice in the accuracy of a graph restored from the lossy reduced graph.

While the optional lossy dropping step 210 may be performed on a lossless reduced graph produced according to process 200, there is no requirement that this be the case. Instead, the optional lossy dropping step 210 may be performed on other reduced graphs encompassing a summary graph S and a residual graph R produced by other graph summarization processes.

In general, the lossy dropping step 210 involves greedily considering each edge of an input residual graph in turn for dropping and then greedily considering each superedge of an input summary graph in turn for dropping. For each such edge in the summary graph and the residual graph, if dropping the edge would not violate an accuracy error condition on a graph restored from a current summary graph and a current residual graph, then the edge is dropped from the current summary graph or the current summary graph. If an edge is dropped, then a new current residual graph or a new current summary graph is generated that does not have the dropped edge.

Dropping an edge may involve updating an adjacency list to remove adjacencies from node objects and in some cases removing entire node objects from the adjacency list. In either case, the data storage size of the adjacency list is reduced. For example, when dropping all edges from residual graph 110-D of FIG. 1D to produce empty residual graph 110-H of FIG. 1H, node objects for nodes ‘a’, ‘c’, ‘d’, ‘e’, and ‘g’ may be removed from adjacency list 106-D of FIG. 1D resulting in adjacency list 106-H of FIG. 1H.

The accuracy error condition may be a function of the error bound e obtained 202 as an input parameter of process 200. In some embodiments, an edge E of a current residual graph R or a current summary graph S is not dropped unless the following accuracy error condition is satisfied for each node u in an input graph G:

| [symbol] −Nᵤ|+|Nᵤ− [symbol] |≤∈|Nᵤ|

Here, the parameter [symbol] represents the set of adjacencies of node u in a graph restored from the current summary graph S and the current residual graph R with the edge E dropped. The parameter Nᵤ represents the set of adjacencies of node u in the input graph G. The parameter ∈ is the error bound e, which is typically expressed as percentage (e.g., 50%). As such, the edge E is not dropped unless, for each node of the input graph, the number of nodes of the symmetric difference (disjunctive union) between: (a) the node's adjacencies in a lossy graph restored from the current summary graph S and the current residual graph R with the edge E dropped, and (b) the node's adjacencies in the input graph, is at most E percentage of the number of (b) the node's adjacencies in the input graph.

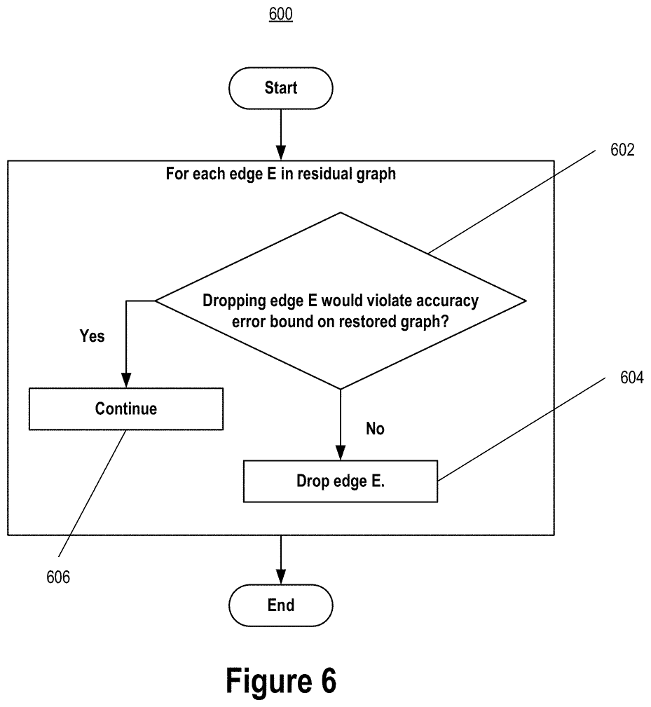

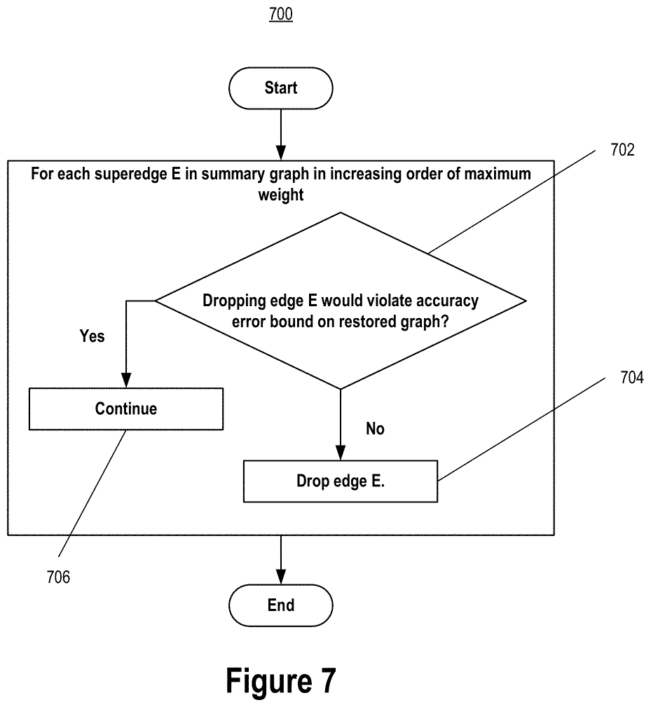

FIG. 6 depicts a process 600 for dropping edges of an input residual graph. Steps 602, 604, and 606 are repeatedly performed for each edge E of the input residual graph in the context of a current summary graph S and a current residual graph R. Initially, the current summary graph S and the current residual graph R may be the summary graph and the residual graph, respectively, input to the lossy dropping step 210. For example, the summary graph and the residual graph input to the lossy dropped step 210 may be a summary graph and a residual graph, respectively, of a lossless reduced graph produced by the lossless summarization steps of process 200.

At step 602, if dropping the current edge E would violate 602 the accuracy error condition on a graph restored from the current summary graph S and the current residual graph R, then the current edge E is not dropped from the current residual graph R and the process 600 continues 606 to consider the next edge in the input residual graph in the context of the current summary graph S and the current residual graph R. On the other hand, if dropping the current edge E would not violate 602 the accuracy error condition on the restored graph, then the current edge E is dropped 604 from the current residual graph R to produce a new current residual graph R and the process 600 continues to consider the next edge in the input residual graph in the context of the current summary graph S (which was unchanged) and the new current residual graph R. The result of process 600 is that one or more of the edges of the input residual graph R may be dropped.

FIG. 7 depicts a process 700 for dropping superedges of an input summary graph. Steps 702, 704, and 706 are repeatedly performed for each superedge E of the input summary graph in increasing order of maximum weight. The maximum weight of a superedge between supernodes X and Y may be defined as the product of the numbers of nodes contained in the supernodes. For example, if two nodes are contained in supernode X and four nodes are contained in supernode Y, the maximum weight of a superedge between X and Y is 8.

Steps 702, 704, and 706 are repeatedly performed for each superedge of the E of the input summary graph in the context of a current summary graph S and a current residual graph R. Initially, the current summary graph S and the current residual graph R may be the summary graph input to the lossy dropping step 210 and the current residual graph R output by process 600, respectively.

At step 702, if dropping the current superedge E would violate 702 the accuracy error condition on a graph restored from the current summary graph S and the current residual graph R, then the current superedge E is not dropped from the current summary graph and the process 700 continues 706 to consider the next superedge in the input summary graph in the context of the current summary graph S and the current residual graph R. On the other hand, if dropping the current superedge E would not violate 702 the accuracy error condition on the restored graph, then the current superedge E is dropped 704 from the current summary graph S to produce a new current summary graph S and the process 700 continues to consider the next superedge in the input summary graph S in the context of the new current summary graph S and the current residual graph R. The result of process 700 is that one or more of the superedges of the input summary graph S may be dropped.

Note that while process 700 may be performed in conjunction with process 600 as described above, it is also possible to perform one of these processes without the other. For example, the lossy dropping step 210 may encompass performing just process 600 for dropping edges of an input residual graph without performing process 700 for dropping edges of an input summary graph. Alternatively, the lossy dropping step 210 may encompass performing just process 700 for dropping edges of an input summary graph without performing process 600 for dropping edges of an input residual graph

### Compressing Step

The optional compressing step 212 may be performed on a summary graph S and a residual graph R such as those that may be output by the lossless or lossy summarization processes disclosed herein. The optional compressing step 212 may involve using a known graph compression algorithm to provide further data storage savings beyond what is provided by the lossless or lossy summarization processes. Such known graph compression algorithms may include any suitable graph compression algorithm according to the requirements of the particular implementation at hand such as for example one of the following known graph compression algorithms:
Run-length encoding;
The virtual node mining approach described in Buehrer, Gregory, and Kumar Chellapilla. “A scalable pattern mining approach to web graph compression with communities.” Proceedings of the 2008 International Conference on Web Search and Data Mining. ACM, 2008;
The WebGraph compression technique described in Boldi, Paolo, and Sebastiano Vigna. “The webgraph framework I: compression techniques.” Proceedings of the 13th international conference on World Wide Web. ACM, 2004; or
The breadth first search approach described in Apostolico, Alberto, and Guido Drovandi. “Graph compression by BFS.” Algorithms 2.3 (2009): 1031-1044.

### Large-Scale Graph Summarization

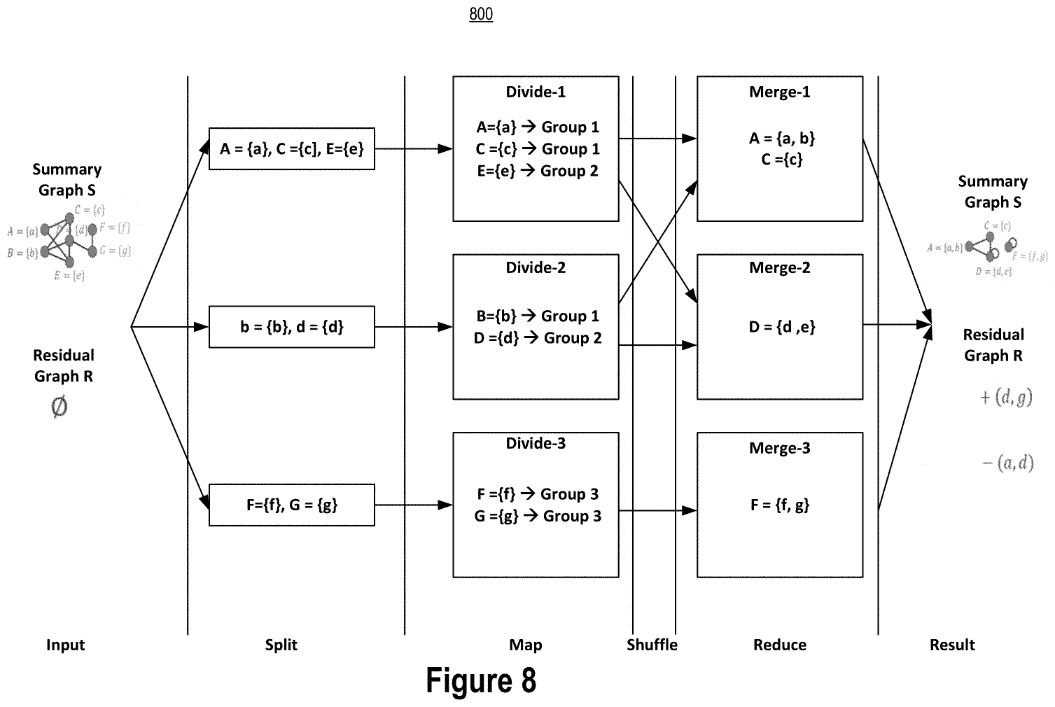

FIG. 8 depicts a large-scale graph summarization system 800, according to some embodiments. The system 800 is configured to perform lossless graph summarization as described above with respect to process 200 described above. In particular, the system 800 is configured to perform the dividing step 206 and the merging step 208 of process 200 in a parallel processing manner according to a map-reduce framework.

Very generally, the map-reduce framework is a programming model and associated implementation for processing large-scale data sets in a parallel and distributed manner on a plurality of processors. The processors are typically provided by a plurality of computer systems configured in a distributed computing system, but may be provided by a single computer system as a plurality of processor cores of the single computer system. As such, the term “processor,” as used herein, can refer to any of a general-purpose microprocessor, a central processing unit (CPU) or a core thereof, a graphics processing unit (GPU), or a system on a chip (SoC).

A computer program that executes on a map-reduce computing system is typically composed of a map program and a reduce program. The map-reduce computing system orchestrates the execution of the map program and the reduce program including executing tasks thereof in parallel and managing data communications between the tasks.

In some embodiments, the system 800 includes a map-reduce computing system and the dividing step 206 of process 200 is implemented as a map program in the map-reduce system 800 and the merging step 208 of process 200 is implemented as a reduce program in the map-reduce system. By doing so, large-scale graphs can be summarized more quickly in part because of the parallelization of the dividing 206 and merging 208 steps.

This parallelization is illustrated by example in FIG. 8. The system 800 includes an input summary graph S and residual graph R. In this example, the input summary graph S is summary graph 302-A of FIG. 3A and the input residual graph R is an empty graph. In a practical implementation, the input summary graph S may have many more nodes and edges such as for example hundreds of millions of nodes and tens of billions of edges therebetween. Further, while in the example of FIG. 8, the input residual graph R is empty, the input residual graph R may have one or more positive edges and/or one or more negative edges. For example, the input summary graph S and the input residual graph R could be a summary graph and a residual graph output by the preceding iteration of the dividing step 206 and the merging step 208.

The input summary graph S and the input residual graph R may be provided by reference (pointer or address) to one or more adjacency lists (or other graph representation) stored in storage media. As such, it may not be necessary to create a separate copy of the input summary graph S and the input residual graph R in order to be provided as input to system 800.

Next, the supernodes of the input summary graph S are split among a set of a plurality of dividing step tasks (e.g., Divide-1, Divide-2, and Divide-3) where each dividing step task executes on a processor. Significantly, dividing step tasks can execute concurrently (in parallel with one another) on different processors, for performance. Further, since supernodes of the input summary graph S can be assigned to a group by the dividing step 206 independent of other supernodes of the input summary graph S, the supernodes of the input summary graph S can be split among the dividing step tasks independently (e.g., randomly).

Each dividing step task (e.g., Divide-1) may compute the minimum hashes of the supernodes that it processes as described above with respect to process 400 of FIG. 4. To do this, a dividing step task requires only the node objects from the adjacency list for the input graph G for the nodes contained in the supernode. Thus, a dividing step task can assign a supernode to a group by storing only at most a very small portion of the adjacency list of the input graph G in-memory at once, thereby having a very efficient use of main memory.

During the shuffle phase of the map-reduce processing, the minimum hash values computed for the supernodes by the dividing step tasks are communicated to a set of a plurality of merging step tasks (e.g., Merge-1, Merge-2, and Merge3) in association with identifiers of the supernodes. Thus, for example, merging step task Merge-1 receives all supernodes assigned to Group 1, merging step task Merge-2 receives all supernodes assigned to Group 2, and merging step task Merge-3 receives all supernodes assigned to Group 3. Here, Group 1, Group 2 and Group 3 represent the set of distinct minimum hash values calculated by the dividing step 206 for the supernodes of the input summary graph S. Thus, supernodes A, B, and C all have the same minimum hash value designated as Group 1, supernodes D and E all have the same minimum hash value designated as Group 2, and supernodes F and G all have the same minimum hash value designated as Group 3.

Each merging step task (e.g., Merge-1) may merge supernodes in the group of supernodes that it processes as described above with respect to process 500 of FIG. 4. To do this for two candidate supernodes, a merging step task requires only the node objects from the adjacency list for the input graph G for the nodes contained in the two supernodes and the node objects from the adjacency list for the input residual graph R for any positive or negative edges that refer to the nodes contained in the two supernodes. Thus, a merging step task can merge two candidate supernodes in a group by storing only at most a very small portion of the adjacency list of the input graph G in-memory at once and a very small portion of the adjacency list of the input residual graph R, thereby having a very efficient use of main memory.

The result of the map-reduce processing is a new summary graph and a new residual graph which may serve as input to another map-reduce processing iteration, or be provided as final output of the system 800.

### Example Computer System

FIG. 9 is a block diagram of an example computer system 900 that may be used in an implementation of graph summarization techniques disclosed herein.

Computer system 900 includes bus 902 or other communication mechanism for communicating information, and one or more hardware processors coupled with bus 902 for processing information. Hardware processor 904 may be, for example, a general-purpose microprocessor, a central processing unit (CPU) or a core thereof, a graphics processing unit (GPU), or a system on a chip (SoC).

Computer system 900 also includes a main memory 906, typically implemented by one or more volatile memory devices, coupled to bus 902 for storing information and instructions to be executed by processor 904. Main memory 906 also may be used for storing temporary variables or other intermediate information during execution of instructions by processor 904. Computer system 900 may also include read-only memory (ROM) 908 or other static storage device coupled to bus 902 for storing static information and instructions for processor 904. A storage system 910, typically implemented by one or more non-volatile memory devices, is provided and coupled to bus 902 for storing information and instructions.

Computer system 900 may be coupled via bus 902 to display 912, such as a liquid crystal display (LCD), a light emitting diode (LED) display, or a cathode ray tube (CRT), for displaying information to a computer user. Display 912 may be combined with a touch sensitive surface to form a touch screen display. The touch sensitive surface is an input device for communicating information including direction information and command selections to processor 904 and for controlling cursor movement on display 912 via touch input directed to the touch sensitive surface such by tactile or haptic contact with the touch sensitive surface by a user's finger, fingers, or hand or by a hand-held stylus or pen. The touch sensitive surface may be implemented using a variety of different touch detection and location technologies including, for example, resistive, capacitive, surface acoustical wave (SAW) or infrared technology.

Input device 914, including alphanumeric and other keys, may be coupled to bus 902 for communicating information and command selections to processor 904.

Another type of user input device may be cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Instructions, when stored in non-transitory storage media accessible to processor 904, such as, for example, main memory 906 or storage system 910, render computer system 900 into a special-purpose machine that is customized to perform the operations specified in the instructions. Alternatively, customized hard-wired logic, one or more ASICs or FPGAs, firmware and/or hardware logic which in combination with the computer system causes or programs computer system 900 to be a special-purpose machine.

A computer-implemented process may be performed by computer system 900 in response to processor 904 executing one or more sequences of one or more instructions contained in main memory 906. Such instructions may be read into main memory 906 from another storage medium, such as storage system 910. Execution of the sequences of instructions contained in main memory 906 causes processor 904 to perform the process. Alternatively, hard-wired circuitry may be used in place of or in combination with software instructions to perform the process.

The term “storage media” as used herein refers to any non-transitory media that store data and/or instructions that cause a machine to operate in a specific fashion. Such storage media may comprise non-volatile media (e.g., storage system 910) and/or volatile media (e.g., main memory 906). Non-volatile media includes, for example, read-only memory (e.g., EEPROM), flash memory (e.g., solid-state drives), magnetic storage devices (e.g., hard disk drives), and optical discs (e.g., CD-ROM). Volatile media includes, for example, random-access memory devices, dynamic random-access memory devices (e.g., DRAM) and static random-access memory devices (e.g., SRAM).

Storage media is distinct from but may be used in conjunction with transmission media. Transmission media participates in transferring information between storage media. For example, transmission media includes coaxial cables, copper wire and fiber optics, including the circuitry that comprise bus 902. Transmission media can also take the form of acoustic or light waves, such as those generated during radio-wave and infra-red data communications.

Computer system 900 also includes a network interface 918 coupled to bus 902. Network interface 918 provides a two-way data communication coupling to a wired or wireless network link 920 that is connected to a local, cellular or mobile network 922. For example, communication interface 118 may be IEEE 802.3 wired “ethernet” card, an IEEE 802.11 wireless local area network (WLAN) card, a IEEE 802.15 wireless personal area network (e.g., Bluetooth) card or a cellular network (e.g., GSM, LTE, etc.) card to provide a data communication connection to a compatible wired or wireless network. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through network 922 to local computer system 924 that is also connected to network 922 or to data communication equipment operated by a network access provider 926 such as, for example, an internet service provider or a cellular network provider. Network access provider 926 in turn provides data communication connectivity to another data communications network 928 (e.g., the internet). Networks 922 and 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the networks 922 and 928, network link 920 and communication interface 918. In the internet example, a remote computer system 930 might transmit a requested code for an application program through network 928, network 922 and communication interface 918. The received code may be executed by processor 904 as it is received, and/or stored in storage device 910, or other non-volatile storage for later execution.

### Extensions and Alternatives

In the foregoing detailed description, various embodiments of lossless and lossy large-scale graph summarization have been described with reference to numerous specific details that may vary from implementation to implementation. The specification and drawings are, accordingly, to be regarded in an illustrative rather than a restrictive sense.

1. A method, comprising:
initializing an input summary graph based on an input graph;
iteratively dividing supernodes of an input summary graph into groups and merging supernodes within groups for a number of iterations in a parallel processing manner such that group identifiers are determined for different supernodes in parallel on different processors and such that supernodes within different groups are merged in parallel on different processors;
based on the iteratively dividing and merging, storing an output summary graph and an output residual graph, the output summary graph having fewer edges that the input graph, the output residual graph having one or more positive edges and/or one or more negative edges to apply to the output summary graph; and
wherein the method is performed by a computing system having one or more processors and storage media storing one or more programs, the one or more programs including instructions configured to perform the method.

2. The method of claim 1, further comprising:
further summarizing the output summary graph in a lossy manner by dropping a superedge of the output summary graph according to an accuracy error condition to produce a lossy summary graph that does not violate the accuracy error condition.

3. The method of claim 2, wherein the accuracy error condition is that all nodes of the input graph are included in a lossy restored graph and, for each node of the lossy restored graph, a number of nodes in a symmetric difference between a first set of the node's adjacencies in the lossy restored graph and a second set of the node's adjacencies in the input graph is at most an error bound number of nodes, the error bound number of nodes based on a percentage of a number of nodes in the second set of the node's adjacencies in the input graph.

4. The method of claim 1, further comprising:
further summarizing the output summary graph in a lossy manner by dropping a positive edge or a negative edge of the output residual graph according to an accuracy error condition to produce a lossy residual graph that does not violate the accuracy error condition.

5. The method of claim 4, wherein the accuracy error condition is that all nodes of the input graph are included in a lossy restored graph and, for each node of the lossy restored graph, a number of nodes in a symmetric difference between a first set of the node's adjacencies in the lossy restored graph and a second set of the node's adjacencies in the input graph is at most an error bound number of nodes, the error bound number of nodes based on a percentage of a number of nodes in the second set of the node's adjacencies in the input graph.

6. The method of claim 1, wherein the iteratively dividing supernodes of the input summary graph into groups for the number of iterations in the parallel processing manner such that group identifiers are determined for different supernodes in parallel on different processors includes, for each of the number of iterations:
generating a random hash function configured to randomly map each node of the input graph to an integer in a range based on a total number of nodes of the input graph without collisions; and
for each supernode of a current summary graph, assign the supernode to a group based on applying the random hash function to each node contained in the supernode and to each adjacency of each node contained in the supernode.

7. The method of claim 1, wherein the iteratively merging supernodes within groups for the number of iterations in the parallel processing manner such that supernodes within different groups are merged in parallel on different processors includes, for each of the number of iterations:
for each supernode A in a group of supernodes, finding an unmerged supernode B in the group of supernodes that maximizes a similarity measure with the supernode A, and merging supernodes A and B based on determining that merging A and B would provide an edge savings equal to or greater than an edge savings threshold that decreases across the number of iterations.

8. One or more non-transitory computer-readable media storing one or more programs, the one or more programs including instructions configured for:
initializing an input summary graph based on an input graph;
iteratively dividing supernodes of an input summary graph into groups and merging supernodes within groups for a number of iterations in a parallel processing manner such that group identifiers are determined for different supernodes in parallel on different processors and such that supernodes within different groups are merged in parallel on different processors; and
based on the iteratively dividing and merging, storing an output summary graph and an output residual graph, the output summary graph having fewer edges that the input graph, the output residual graph having one or more positive edges and/or one or more negative edges to apply to the output summary graph.

9. The one or more non-transitory computer-readable media of claim 8, the instructions further configured for:
further summarizing the output summary graph in a lossy manner by dropping a superedge of the output summary graph according to an accuracy error condition to produce a lossy summary graph that does not violate the accuracy error condition.

10. The one or more non-transitory computer-readable media of claim 9, wherein the accuracy error condition is that all nodes of the input graph are included in a lossy restored graph and, for each node of the lossy restored graph, a number of nodes in a symmetric difference between a first set of the node's adjacencies in the lossy restored graph and a second set of the node's adjacencies in the input graph is at most an error bound number of nodes, the error bound number of nodes based on a percentage of a number of nodes in the second set of the node's adjacencies in the input graph.

11. The one or more non-transitory computer-readable media of claim 8, the instructions further configured for:
further summarizing the output summary graph in a lossy manner by dropping a positive edge or a negative edge of the output residual graph according to an accuracy error condition to produce a lossy residual graph that does not violate the accuracy error condition.

12. The one or more non-transitory computer-readable media of claim 11, wherein the accuracy error condition is that all nodes of the input graph are included in a lossy restored graph and, for each node of the lossy restored graph, a number of nodes in a symmetric difference between a first set of the node's adjacencies in the lossy restored graph and a second set of the node's adjacencies in the input graph is at most an error bound number of nodes, the error bound number of nodes based on a percentage of a number of nodes in the second set of the node's adjacencies in the input graph.

13. The one or more non-transitory computer-readable media of claim 8, wherein the iteratively dividing supernodes of the input summary graph into groups for the number of iterations in the parallel processing manner such that group identifiers are determined for different supernodes in parallel on different processors includes, for each of the number of iterations:
generating a random hash function configured to randomly map each node of the input graph to an integer in a range based on a total number of nodes of the input graph without collisions; and
for each supernode of a current summary graph, assign the supernode to a group based on applying the random hash function to each node contained in the supernode and to each adjacency of each node contained in the supernode.

14. The one or more non-transitory computer-readable media of claim 8, wherein the iteratively merging supernodes within groups for the number of iterations in the parallel processing manner such that supernodes within different groups are merged in parallel on different processors includes, for each of the number of iterations:
for each supernode A in a group of supernodes, finding an unmerged supernode B in the group of supernodes that maximizes a similarity measure with the supernode A, and merging supernodes A and B based on determining that merging A and B would provide an edge savings equal to or greater than an edge savings threshold that decreases across the number of iterations.

15. A computing system, comprising:
a plurality of processors;
storage media; and
one or more programs stored in the storage media and having instructions configured for:
initializing an input summary graph based on an input graph;
iteratively dividing supernodes of an input summary graph into groups and merging supernodes within groups for a number of iterations in a parallel processing manner such that group identifiers are determined for different supernodes in parallel on different processors of the plurality of processors and such that supernodes within different groups are merged in parallel on different processors of the plurality of processors; and
based on the iteratively dividing and merging, storing an output summary graph and an output residual graph, the output summary graph having fewer edges that the input graph, the output residual graph having one or more positive edges and/or one or more negative edges to apply to the output summary graph.

16. The computing system of claim 15, the instructions further configured for:
further summarizing the output summary graph in a lossy manner by dropping a superedge of the output summary graph according to an accuracy error condition to produce a lossy summary graph that does not violate the accuracy error condition.

17. The computing system of claim 16, wherein the accuracy error condition is that all nodes of the input graph are included in a lossy restored graph and, for each node of the lossy restored graph, a number of nodes in a symmetric difference between a first set of the node's adjacencies in the lossy restored graph and a second set of the node's adjacencies in the input graph is at most an error bound number of nodes, the error bound number of nodes based on a percentage of a number of nodes in the second set of the node's adjacencies in the input graph.

18. The computing system of claim 15, the instructions further configured for:
further summarizing the output summary graph in a lossy manner by dropping a positive edge or a negative edge of the output residual graph according to an accuracy error condition to produce a lossy residual graph that does not violate the accuracy error condition.

19. The computing system of claim 18, wherein the accuracy error condition is that all nodes of the input graph are included in a lossy restored graph and, for each node of the lossy restored graph, a number of nodes in a symmetric difference between a first set of the node's adjacencies in the lossy restored graph and a second set of the node's adjacencies in the input graph is at most an error bound number of nodes, the error bound number of nodes based on a percentage of a number of nodes in the second set of the node's adjacencies in the input graph.

20. The computing system of claim 15, wherein the iteratively dividing supernodes of the input summary graph into groups for the number of iterations in the parallel processing manner such that group identifiers are determined for different supernodes in parallel on different processors includes, for each of the number of iterations:
generating a random hash function configured to randomly map each node of the input graph to an integer in a range based on a total number of nodes of the input graph without collisions; and
for each supernode of a current summary graph, assign the supernode to a group based on applying the random hash function to each node contained in the supernode and to each adjacency of each node contained in the supernode.

21. The computing system of claim 15, wherein the iteratively merging supernodes within groups for the number of iterations in the parallel processing manner such that supernodes within different groups are merged in parallel on different processors includes, for each of the number of iterations:
for each supernode A in a group of supernodes, finding an unmerged supernode B in the group of supernodes that maximizes a similarity measure with the supernode A, and merging supernodes A and B based on determining that merging A and B would provide an edge savings equal to or greater than an edge savings threshold that decreases across the number of iterations.
